(19) United States
(12) Patent Application Publication
(10) Pub. No.: US 2009/0063309 A1
(43) Pub. Date: Mar. 5, 2009

(54) System And Method For Automating Engineering Processes For Build-To-Order Projects

(76) Inventor: Tim Stephens, Broomfield, CO (US)

Correspondence Address: LATHROP & GAGE LC, 4845 PEARL EAST CIRCLE, SUITE 300, BOULDER, CO, 80301, US

(21) Appl. No.: 11/848,906

(22) Filed: Aug. 31, 2007

(51) Int. Cl. G06Q 10/00

(52) U.S. Cl. 705/29; 705/400

(57) ABSTRACT

A system, method and software product automate engineering processes for build-to-order (BTO) products. A request for quote (RFQ) for a BTO product is received from a BTO user. A DNA product string is generated based on information contained in the RFQ, the DNA product string defining the BTO product. The DNA product string is validated against pre-defined business rules and a model of the BTO product is generated based on the DNA product string. A quote for the BTO product is determined based upon the RFQ, the model and the DNA product string. The quote includes one or more of a price, a delivery schedule and a bill of materials.

### BACKGROUND

The global manufacturing industry is generally considered to be organized into four geographic regions: North America, United Kingdom, Middle East, and Asia. The North American and United Kingdom regions continue to experience competitive pressure from Middle Eastern and Asian regions. This pressure, especially from Asia, has been centered on price and delivery timing. With a lower labor cost and a relative abundance of people, the Asian sources for manufactured tools can built at around 30% less in cost and delivered about 30-50% faster than from sources in North American regional competitors.

The Build-to-Order (BTO) industry makes custom items to the unique specifications of their customers. Every order begins with a request for quote (RFQ) from a potential customer. A BTO company's response to this RFQ is then created by skilled workers to design, estimate, and process the project.

Thus, the BTO industry has a significant time lapse from receiving an RFQ to receiving payment for the processed job. BTO companies rely upon labor-intensive methods to design, estimate, quote, and process the requested custom components and tooling. Since each potential customer requires a unique price and delivery quote, each transaction necessitates significant front-end customer interaction using telephones, fax machines, and jointly-developed spreadsheets. Since each customer's requirements must be understood correctly, this front-end process is often as unique as the products that are to be produced.

For example, if a typical BTO company has 20 people quoting jobs, these people may employ 20 different methods that result in 20 different price and delivery quotations completed at 20 different times. There is no common work process to reduce errors and minimize execution variation. Where a potential customer send an RFQ for a custom order to several BTO companies, the company with the quickest quote and reliable delivery performance of the custom product has the advantage in winning the order. Conversely, the BTO company that takes longer to respond to an RFQ generally loses the order regardless of their estimated price.

BTO customers are also tend to be frugal. Operating their businesses on small margins, BTO customers routinely chose one BTO company over another based upon as little as a 5%, or less, lower estimated costs. The inability to provide accurate, real-time quotes places BTO companies at a significant disadvantage when competing against global BTO companies.

A major contribution to the problems BTO companies experience is centered on the engineering specification supplied by the customer. The format of the engineering specification and design-intent interpretation of the specification increase cycle time and manufacturing costs for the BTO company. Typical formats of engineering specifications encountered by BTO companies range from cocktail napkin sketches, to two-dimensional conventional CAD engineering drawings, and to three-dimensional solid models. These engineering specifications may involve a complex product selection process that requires engineering calculations and/or engineering decisions related to the application of the product and/or its intended use. This variety of formats inevitably requires the BTO to perform a translation event that could cause data to be lost, potentially affecting design-intent. The conventional, yet incomplete, solution is for the BTO company to either purchase each of the necessary engineering software brands or replicate the design by redesign into a format that they are able to work with. Handling the engineering data twice in the form of replication by redesign is generally mandatory when the RFQ includes conventional paper drawings and customer-supplied rough sketches. This redesign process consumes front-end time for the BTO company and is prone to design-intent interpretation errors.

In fact, design-intent interpretation errors are generally the rule rather than the exception, regardless of how the engineering specification is supplied. Missing features, lack of dimensional tolerances, and errors from incorrect geometry are commonplace in a submitted RFQ. A skilled estimator must either consume time seeking clarification for anomalies within an RFQ from the customer, or the skilled estimator must estimate the project based upon the RFQ as-is and risk producing a “defective” tooling component.

Having interpreted the customer's RFQ, and having produced an engineering specification, the BTO company must next determine how the specified product is to be manufactured. Capability and capacity decisions, based upon the types of machining operations and their sequence needed, are made to determine price and delivery calculations. Factors such as machine set-up and spindle time, labor hours, material requirements, and inventory levels are each elements that can drive the price estimate and delivery timing for the custom-tooling component of the RFQ.

In a typical BTO company, such front-end business decisions require input from many skilled people to complete each quotation. Further, the BTO company usually has a customer service representative as the first point of contact, and an engineer is often involved to answer any technical question raised by the customer.

Often, a designer replicates the engineering drawings supplied by the customer in the RFQ and an estimator determines the manufacturing routing for price and delivery. Once a quoted project becomes an order, a “job traveler” must be created. The job traveler involves generating cutter path programs and shop drawings for manufacturing, and also an operation sequence with material and sourcing specifications.

Therefore, a significant portion of a BTO company's resources are spent interpreting the customer's RFQ, and resolving issues therein, just to enable a quote for the job. The conversion required for competing brands parts can be especially time consuming. The state-of-the-art method for converting complex part numbers between brands generally involves a human skilled in the art making catalog comparisons. Punch equipment conversions, for example, can be particularly complex.

Where a quote is too high, the BTO company may not get the job, and where the quote is too low, the BTO company may lose money on the job if they get it. Thus, despite the cost of the work involved, front end processing is an important step for the BTO company.

### SUMMARY OF THE INVENTION

The following systems and procedures emphasize at least three main areas of improvement. In one such area, a user operates a system using a standard web browser and mouse. The user interface to the system is designed so that each user follows the same method from start to finish, thereby standardizing the working process. In a second area, errors in a bill of materials, a design, and an estimation are caught at the user input stage instead of on the shop floor. Selections made by the user and other user defined input to the application may be validated for function and compliance with company capabilities. In a third area, execution variation is minimized to values near zero. By providing on demand web-based engines, non-skilled entry-level workers, through to highly skilled experts, may successfully create a more standardized request for quote (RFQ) for a Built to Order product.

In one embodiment, a method automates engineering processes for build-to-order (BTO) products. A request for quote (RFQ) for a BTO product is received from a BTO user. A DNA product string is generated based on information contained in the RFQ, the DNA product string defining the BTO product. The DNA product string is validated against pre-defined business rules and a model of the BTO product is generated based on the DNA product string. A quote for the BTO product is determined based upon the RFQ, the model and the DNA product string. The quote includes one or more of a price, a delivery schedule and a bill of materials.

In another embodiment, a computer system automates quotes for build-to-order (BTO) engineering products and includes a user interface for receiving and validating interactive input from a BTO user to form a request-for-quote (RFQ) for a BTO product; a DNA coder-decoder (CODEC) for converting manufacturer specific part numbers to and from a generic DNA product string that defines the BTO product; a modeler for generating a solid model of the BTO product based upon the generic DNA product string; a plurality of business rules that include cost and production information of a BTO company; and an estimator for generating a quote for manufacturing the BTO product based upon the generic DNA product string, the solid model and the plurality of business rules.

In another embodiment, a software product has instructions, stored on computer-readable media, wherein the instructions, when executed by a computer, perform steps for automating quotes for build-to-order (BTO) engineering products. The software product includes instruction for receiving a request for quote (RFQ) from a BTO user for a BTO product; instruction for generating a DNA product string based on information contained in the RFQ, the DNA product string defining the BTO product; instruction for validating the DNA product string against pre-defined business rules; instruction for generating a model of the BTO product based on the DNA product string; and instruction for determining a quote for the BTO product based upon the RFQ, the model and the DNA product string, the quote including one or more of a price, a delivery schedule and a bill of materials.

### BRIEF DESCRIPTION OF THE FIGURES

FIG. 1 shows one exemplary system embodiment for automating engineering processes for build-to-order projects.

FIG. 2 shows another exemplary system embodiment for automating engineering processes for build-to-order projects.

FIG. 3 shows one exemplary method for automating engineering processes for build-to-order projects.

FIG. 4 shows one exemplary system embodiment for updating and maintaining build-to-order company data.

FIG. 5 shows one exemplary method for automating engineering processes for build-to-order projects.

FIGS. 7-15 illustrate exemplary screen shots of interactive web pages that may be generated by the user interface shown in FIGS. 1 and 2.

### DETAILED DESCRIPTION OF THE FIGURES

To improve the efficiency and operation of a build-to-order (BTO) company, the method of receiving and processing potential customers' requirements needs to be simplified and expedited. The following description, systems and methods teach how a BTO company may automate, standardize and improve efficiency in the front-end business processes through use of the automated BTO system.

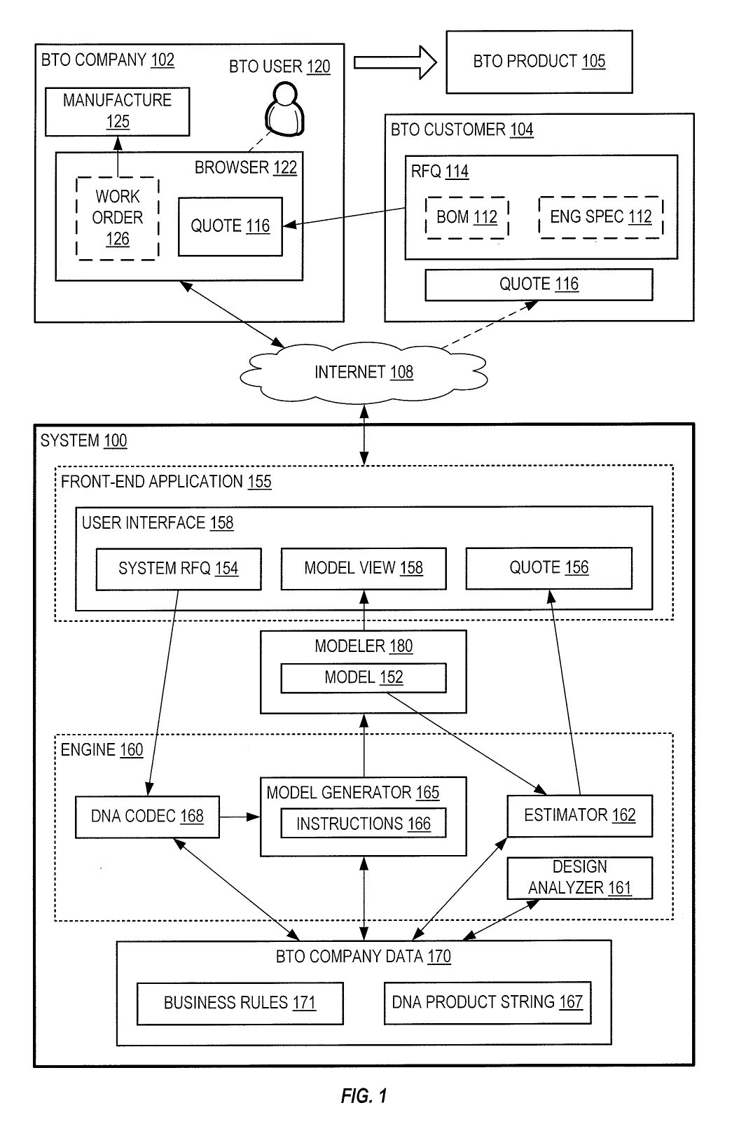

FIG. 1 shows one exemplary system 100 for automating engineering processes of BTO projects to build a BTO product 105. A BTO company 102 manufactures BTO product 105 for a BTO customer 104 based upon a request for quote (RFQ) 114 that is submitted to BTO company 102 by BTO customer 104. RFQ 114 may include one or more of an engineering specification 112 and bill of materials (BOM) 118 that define BTO product 105. RFQ 114 may be sent to BTO company 102 via one or more of: the internet; a telephone; a facsimile; hand delivery; or other known delivery methods. In one example, BTO product 105 is formed of standard components in a configuration defined by BTO customer 104. In another example, BTO product 105 is made from one or more custom-configured components. In yet another example, BTO product 105 is made from one or more custom-manufactured components. BTO product 105 is produced to the specifications defined by BTO customer 104 and may include zero, one, or more standard components, zero, one or more modified components, and zero, one, or more custom-created components.

System 100 includes a front-end application 155, an engine 160, at least one modeler 180, and BTO company data 170. Front-end application 155 includes a user interface 158 that is, for example, a web server.

In the example of FIG. 1, a BTO user 120 within BTO company 102 enters information of RFQ 114 to system 100; the entered information is illustratively shown as system RFQ 154 and may contain additional information supplied by BTO company 102. BTO user 120 may be a BTO company employee and/or contractor hired to enter information to system 100. In one example of operation, BTO user 120 enters data directly into system 100 via browser 122 and internet 108 while receiving RFQ 114 from BTO customer 104.

Engine 160 is shown with a ‘DNA’ coder-decoder (CODEC) 168, an estimator 162, and a model generator 165. DNA CODEC 168 allows engine 160 to convert to and from a ‘DNA’ product string 167 that is formed to describe BTO product 105 based upon information of RFQ 114.

System 100 operates to automate commercial and technical calculations and decisions for engineering transactions without requiring BTO customer 104 to have knowledge of specific solid modeling or other engineering software. In particular, since system 100 includes one or more modelers 180, system 100 reduces the need for BTO companies and BTO customers to maintain multiple operating systems and associated modeling and engineering packages. Thus, BTO company 102 does not become captive to a particular software programming language and/or technology platform since system 100 is accessed via a standard web browser (i.e., web browser 122) which is found on standard personal computers that may include a keyboard, mouse, display screen etc.

RFQ 154 may include models and other uploaded inputs from BTO user 120, as received from BTO customer 104. User interface 158 allows BTO user 120 to follow a standardized methodology for creating RFQ 154. Front-end application 155 provides a standard interface for BTO user 120 and thereby standardizes the required work within BTO company 102 to prepare quotes to RFQ 114. Since front-end application 155 is standardized, it applies common rule validation to user input, thereby mitigating BOM errors and design errors, and also minimizing execution variation. Front-end application 155 further facilitates communication between engine 160 and BTO user 120.

Engine 160 allows for automated engineering-driven product selection. System engine 160 uses certain information of RFQ 154 to generate quote 156 and model view 158, which are accessible by BTO user 120 via internet 108 and browser 122. Information contained in system RFQ 154 is passed to engine 160, which converts manufacturer's complex part numbers and other configuration information to a DNA product string 167, which is stored within BTO company data 170. DNA product string 167 is created by DNA CODEC 168 which may convert complex part number conversions between brands. For example, BTO company 102 may manufacturer its own components, each having a part number unique to BTO company 102, and therefore BTO company 102 would prefer to use these products when manufacturing BTO product 105 for BTO customer 104. However, BTO customer 104 typically utilizes part numbers from one or more other brands within RFQ 114 when specifying BTO product 105. Thus, it is advantageous to be able to determine equivalent parts from multiple suppliers and/or other BTO companies. Since system 100 converts supplied part numbers into DNA product string 167, engine 160 may also convert DNA product string 167, or a part thereof, into part numbers of equivalent products made by other manufacturers.

DNA product string 167 may be generic to all product manufacturers. Engine 160 validates DNA product string 167 and other customer input of RFQ 154 and converts each component within DNA product string 167 into a part number of a preferred brand. The preferred brand may be specified by BTO customer 104, and/or BTO company 102 shows one example of a DNA product string 167 displayed as a table of parameters, values, and levels for a metric heavy duty ball lock punch is output from an exemplary implementation of system 100 and shows DNA product string 167 that was included in quote number 56. The line number of ‘1’ indicates that this parameter is for the first DNA product string 167 of quote 56; the DNA product string is simply broken down in the table for clarity. Column ‘ParamLevel’ of indicates a level of importance of the associated parameter named within the “ParamName’ column. Each named parameter has associated instructions 166 that are sent to modeler 180 by model generator 165 based upon the parameter name. The order in which these instructions are sent to modeler 180 is based upon each associated parameter level of the parameter name.

Table 2 Manufacturer's Equivalent Parts shows part numbers for equivalent metric heavy duty ball lock punches from three different manufacturers, as defined by exemplary DNA product string 167 of. In particular, the heavy duty ball lock punch in this example has a 20 mm shank that is 115 mm long with a maintained point length of 25 mm for a flatted round shape of 15.00 mm by 6.00 mm with the ball seat at 48-degrees, a rooftop shear with an angle of 15-degrees, and ejector with no side hole made from M2. Each manufacturer's specification, however, may differ in: the sequence of overall length and point length in the text strings, the standard point range, the point length (e.g., some brands maintain the point length and others do not), the standard shapes (e.g., standard shapes for one brand are classified shapes for others), the alteration codes, and the side holes (e.g., some brands offer side holes and others do not).

TABLE 1
EXAMPLE DNA PRODUCT STRING

| Quote # | Line # | ParamName | ParamVal | ParamLevel |
|---|---|---|---|---|
| 56 | 1 | Code_Product | PP | 0 |
| 56 | 1 | Code_Unit | I | 0 |
| 56 | 1 | d_Method | 1 | 0 |
| 56 | 1 | e1_Brand | Moeller | 1 |
| 56 | 1 | e2_Brand_Code | IER | 2 |
| 56 | 1 | e3_Brand_Display Code | REG | 1 |
| 56 | 1 | f4_CrossOverB | 1.5 | 10 |
| 56 | 1 | f4_CrossOverSBR | 1.09 | 10 |
| 56 | 1 | g1_IsClassified | FALSE | 2 |
| 56 | 1 | i1_TP_DGroup | DC | 4 |
| 56 | 1 | i2_TP_DValue | 0.75 | 4 |
| 56 | 1 | j_LBOrder | LB | 2 |
| 56 | 1 | k1_TP_L_BrandVal | 400 | 6 |
| 56 | 1 | k2_TP_L_TPVal | | 6 |
| 56 | 1 | l1_TP_B_BrandVal | E | 7 |
| 56 | 1 | l2_TP_B_TPVal | 1.5 | 7 |
| 56 | 1 | m1_PVal | 0.545 | 10 |
| 56 | 1 | m1b_IsXP | FALSE | 10 |
| 56 | 1 | m2_WVal | 0.324 | 10 |
| 56 | 1 | m2b_IsXW | FALSE | 10 |
| 56 | 1 | n1_LockDevGrp | SBS | 11 |
| 56 | 1 | n2_LockDevCode | SBS | 11 |
| 56 | 1 | n2x_LDVars_A | 0.4375 | 11 |
| 56 | 1 | n2x_LDVars_AA | 11.5 | 11 |
| 56 | 1 | n2x_LDVars_B | 0.5 | 11 |
| 56 | 1 | n2x_LDVars_Ball | 0.5 | 11 |
| 56 | 1 | n2x_LDVars_C | 1.3125 | 11 |
| 56 | 1 | n2x_LDVars_D | 0.3349 | 11 |
| 56 | 1 | n2x_LDVars_IsLoaded | TRUE | 11 |
| 56 | 1 | n2x_LDVars_R | 0.235 | 11 |
| 56 | 1 | n4_Y_IsChecked | TRUE | 11 |
| 56 | 1 | n4_YVal | 46 | 11 |
| 56 | 1 | n9b_Eject_KP_Filter | — | 11 |
| 56 | 1 | °0_Eject_C | 0.223 | 12 |
| 56 | 1 | °0_Eject_E | 0.094 | 12 |
| 56 | 1 | °0_Eject_ED | 0.06 | 12 |
| 56 | 1 | °0_Eject_TapD | 0.25 | 12 |
| 56 | 1 | °0_EjectIsSpecial | FALSE | 12 |
| 56 | 1 | °0_EjectXRef | KP9 | 12 |
| 56 | 1 | °6a_Sheer_Val | 1 | 12 |
| 56 | 1 | °6b_Sheer_Datum | 0 | 12 |
| 56 | 1 | °6b_Sheer_Datum_IsFromTxtB | FALSE | 12 |
| 56 | 1 | °6c_Sheer_A | 30 | 12 |
| 56 | 1 | p0_Price | 74.7448 | 13 |
| 56 | 1 | p0_PriceIsSpecial | FALSE | 13 |
| 56 | 1 | p0_PriceOverride | 74.74 | 13 |
| 56 | 1 | p0_QtyAndPriceIsSet | TRUE | 13 |
| 56 | 1 | p0_Quantity | 51 | 13 |
| 56 | 1 | p1_Material | M2 | 13 |
| 56 | 1 | p1_MaterialGroup | MAT3 | 13 |
| 56 | 1 | p1_MaterialIsSpecial | FALSE | 13 |
| 56 | 1 | p2_Coating | None/Heat Treated | 13 |
| 56 | 1 | p2_CoatingGroup | COAT1 | 13 |
| 56 | 1 | p2_CoatingIsSpecial | FALSE | 13 |
| 56 | 1 | p3_CoatingDays | 0 | 13 |
| 56 | 1 | p3_MaterialDays | 0 | 13 |
| 56 | 1 | p3_QuantityDays | 8 | 13 |
| 56 | 1 | p3_XChangeDays | 1 | 13 |
| 56 | 1 | p4_TotalDays | 9 | 13 |
| 56 | 1 | TPCode | BHPER | 2 |

Continuing with the example of FIG. 1, engine 160 may use a design analyzer 161 and one or more pre-defined business rules 171 to ensure function and compliance of RFQ 154 with capabilities of BTO company 102. Early validation of RFQ 154 allows errors to be caught prior to manufacture 125 of BTO product 105. BTO company data 170 may store additional company specific information of BTO company 102 including capabilities of the BTO company. As shown, these capabilities may be encoded as business rules 171 which prevent system 100 from generating quote 156 for a product that is beyond the capabilities of BTO company 102.

Once quote 156 is generated, BTO user 120 may view, print, email, fax, or download the quote as desired.

TABLE 2
MANUFACTURER'S EQUIVALENT PARTS

| Manufacturer | Part Number |
|---|---|
| Moeller | MEF 20-125 C P = 15.00 XW = 6.00, |
| | X1 L = 115.0 BS @ 48o S3 A = 15o |
| | MAE6 Ejector Kit-No Side Hole-M2 |
| Lane | BEHC 20-25-125 M2 C117 P15.00 W6.00 |
| | BS-48o AL115.0 AB35.0 |
| | E9M Ejector Kit-Rooftop Shear |
| | Angle = 15o No Side Hole |
| Pivot | HMEF 20 125 B P15.00 SW6.00 SL115.0 |
| | SB35.0 B/S48o ME-9 Ejector |
| | Kit-Rooftop Shear Angle = 15o M2 |

Within engine 160, model generator 165 creates model 152 using modeler 180 and DNA product string 167 and optionally some other input contained in system RFQ 154. Model generator 165 may select one or more modelers 180 to generate model 152 and model view 158. In one embodiment, system RFQ 154 specifies the type of model to generate (i.e., a file format), thereby determining which modeler 180 to use. Modeler 180 may represent one or more of Catia Solid Modeler, ProE Solid Modeler, SolidWorks Solid Modeler, UG NX Solid Modeler, and CAM Modeler Module, and other modelers. Engine 160 utilizes model generator 165 to generate instructions 166 based upon DNA product string 167 and customer input contained in system RFQ 154. Instructions 166 are then input to modeler 180 to generate model 152 and model view 158. Model 152 and/or model view 158 may be in the form of one or more of: an interactive three-dimensional (3D) model; a photo-realistically shaded solid body; and one or more two-dimensional (2D) engineering drawings. Such automated model generation mitigates many engineering file format and design-intensive issues because model generator 165 may output instructions 166 to operate modeler 180 to generate model 152 in all major native and common design file formats used by 2D/3D and solid model design tools. Thus, BTO user 120 may view, download, and operate with the same data even when using different modeling tools. Front-end application 155 may also notify BTO user 120 of deficiencies when a selected file format is not compatible.

Engine 160 need not store model 152 since BTO product 105 is stored as a digital DNA product string 167 within BTO company data 170 and engine 160 may rapidly recreate model 152 from DNA product string 167 as desired. Thus, space is saved within system 100 as compared to typical 3D model storage systems, since the 3D model need not be stored. Additionally, the core software of engine 160 is protected from API language changes within modeler 180. If the programming language of modeler 180 changes, the only the bridge portion of engine 160 software need be changed.

The “burn time” or creation process of model generator 165 is measured in seconds and the generator thus generates model 152 and model view 158 relatively quickly. Model 152 may be presented as model view 158, via Internet 108 and browser 112, to BTO user 120, in the form of one or more of: an interactive three-dimensional (3D) model; a photo-realistically shaded solid body; and one or more two-dimensional (2D) engineering drawings. For example, BTO user 120 may download model 152 as a first file type and BTO customer 104 may download model 152 as another file type as desired. In particular, BTO company 102 may use a specific file type for product manufacture 125, while BTO customer 104 only needs to review final product specifications.

RFQ 154 may specify the format type of model 152 generated by model generator 165. Modeler brand(s) may include: Catia Solid Modeler; ProE Solid Modeler; SoildWorks Solid Modeler; UG NX Solid Modeler; and CAM Modeler Module. Model generator 165 utilizes the digital DNA product string and format type information to determine logic and design rules and to create instructions 166 for modeler 180. Using instructions 166, modeler 180 creates model 152. Thus, model generator 165 acts as a bridge between engine 160 and modeler 180. In one example, these instructions are sent through middleware that bridges system engine 160 to the modeler 180. Model 152 may be built at any time, and is therefore available anytime for preview and download by BTO user 120 via internet 108 and web browser 122.

Estimator 162 uses model 152 to determine product specific information (e.g., mass property data, weight, center of mass, etc.). This information may then be used along with other calculations and decisions to determine an estimate of the price and delivery time for BTO product 105 for inclusion within quote 156. Quote 156 may also include a BOM for output and/or download in a variety of formats selectable by BTO user 120. Estimator 162 may also use information provided by BTO company profile 170 to generate quote 156.

Quote 156 may be viewed, via internet 108, by both BTO company 102 and BTO customer 104. For example, BTO user 120 may interactively view quote 156 prior to sending quote 156 to BTO customer 104 as quote 116. User 120 may also request a work order 126, based upon quote 156 and DNA product string 167, to allow manufacturing processes to be viewed prior to sending quote 156 to customer 104 (illustratively shown as quote 116 within BTO customer 104). Through user interface 158, BTO user 120 is able to preview and/or download the design, BOM, and delivery schedule. The design, BOM, and delivery schedule, shown as RFQ response 156, are accessible by BTO user 120 at any time.

BTO company data 170 may also include manufacturing capabilities (not shown) of BTO company 102 and associated prices. That is, BTO company data 170 also stores information specific to BTO company 102 including: address; phone; billing; manufacturing data; BTO customer data; etc. As appreciated, system 100 may support a plurality of BTO companies 102 and BTO customers 104, each BTO company 102 having separate BTO company data 170.

DNA product string 167 also allows BTO company 102 to track perishable components and replacement parts for BTO product 105. Certain components of BTO product 105 (e.g., punches) are considered perishable as they have a finite useful life; they wear out with use and require replacement. BTO company data 170 also allows engine 160 to track perishable components and other replacement parts specified by DNA product string 167. Thus, engine 160 identifies standard and/or custom products that are perishable and determines replacement time intervals based upon predicted usage information provided by BTO customer 104. For example, BTO customer 104 may provided information on cycle rate and cycles per hour, day, week, month, or year that allow engine 160 to make calculations and decisions regarding expected life and to forecast replacement intervals that may be stored within BTO company data 170.

BTO company data 170 may also list replacement parts for BTO product 105 based upon DNA product string 167. Where BTO product 105 is a punch cam unit, several replacement parts within the tooling assembly may need to be ordered. System 100 includes functionality that allows BTO user 120 to select an assembly part number and interactively obtain a Bill of Materials (BOM) for BTO product 105 including accessories and options specific to BTO product 105. System 100 generates automatic reminders of replacement components for BTO customer 104 based upon predicted lifetime of perishable components and sent (e.g., by one or more of email, fax, etc.) to BTO customer 104. Thus BTO customer 104 receives a reminder to order these replacement parts such that no BTO product downtime occurs. System 100 may also send the reminder to ordering replacement parts to BTO company 102, thereby allowing sales representative to contact BTO customer 104 to solicit the ordering of replacement parts. BTO user 120 and/or BTO customer 104 may respond to this reminder to recorder parts by interacting with system 100, using web browser 122 for example, choose the tool type, application, and/or part number (or any other search criteria) to access the vaulted Bill of Materials for search result.

In one example of operation, customer 104 telephones BTO company 102 to reorder BTO product 105, whereby user 120 interacts with system 100 to place the order with BTO company 102. In one embodiment, the perishable components within the BOM are pre-selected to facilitate re-ordering by customer 104. These pre-selected items pre-populate a shopping cart of BTO customer 104, for example.

System 100 may generate an automated validation warning based on actual-to-estimated design cost drivers. The key cost drivers for a product are stored within system 100 (e.g., within business rules 171) and may be compared against actual design data. These cost drivers may include one or more of overall size, weight, number of components, number of features and surface area. In one example, where material is a key cost driver, system 100 estimates at least part of BTO product 105 cost by determining material cost based upon a price per unit of weight.

In another example of operation, BTO user 120 creates an engineering model by conventional means and imports that model into system 100. System 100 then analyzes the model to extract mass properties for weight which are then compared to estimated weight properties. The incremental percentage comparison of actual versus estimated weight may be displayed to user 120. If the actual weight exceeds the estimate, BTO user 120 may be alerted by a validation warning to prevent manufacturing errors. System 100 may also generate and send one or more email messages to staff of BTO company 102 to make them aware of potential errors and to request approval to over-ride the potential problem (i.e., to override the violation of business rules 171).

In another embodiment of system 100, FIG. 1, quote 156 is used as part of an automated manufacturing routing of BTO product 105. System 100 replaces many steps previously made by human engineers. For example, business rules 171 may be configured within system 100 for BTO company 102 to make decisions such as “make vs. buy” and “blank vs. bar stock” automatically; these decisions affect if and how a manufacturer fabricates each item. For example, the capability and capacity requirements for a requested product also factor into the routing of the product, since each routing step must occur in a specific sequence from start to finish. System 100 determines routing requirements and makes sequence decisions by associating manufacturing and processing operations to features defined by DNA product string 167. These calculations and decisions may be completely automated with system 100, thereby providing consistency and speed to generating quote 156 and manufacture 125 of BTO product 105.

System 100 may also allow multiple users (e.g., BTO user 120) to collaborate during specification and manufacturing of BTO product 105. For example, each user may be assigned a specific role within system 100. For example, within BTO company 102, one person may create a design for a new BTO product and another person may order items specified by the product's Bill of Material. Accordingly, system 100 includes functionality that is role based to allow these persons to collaborate on the BTO project. A person authorized to buy may then retrieve the stored project and complete the purchase transaction. Multiple projects may be pooled for one buyer (authorized person).

System 100 provides functionality to user 120 to stocklist, process/design, and estimate products such as: punch equipment, die sets, guiding devices, lifter and gage devices, aerial, die mount, and rotary cams, pressure systems, tapping units, rotary-action benders, transfer finger devices, automotive weld tools, checking fixtures, progressive dies, transfer dies, line dies, draw dies, trim dies, pierce dies, form dies, flange dies, and cam dies. A more detailed list of BTO products that system 100 may handle is shown in Table 3 Exemplary BTO Products, below.

TABLE 3
EXEMPLARY BTO PRODUCTS

| | |
|---|---|
| 1. | Pierce punches |
| 2. | Pierce die buttons |
| 3. | Pierce punch retainers |
| 4. | Pierce punch strippers |
| 5. | Pierce punch special retainers |
| 6. | Custom cutting punches |
| 7. | Custom cutting die blocks |
| 8. | Die pressure pads |
| 9. | Die strippers |
| 10. | Form punches |
| 11. | Form die buttons |
| 12. | Thread form punches |
| 13. | Thread form die buttons |
| 14. | Pilot punches |
| 15. | Die sets |
| 16. | Guiding devices |
| 17. | Die lifters |
| 18. | Part / Panel lifters |
| 19. | Gage devices |
| 20. | Aerial cams |
| 21. | Die mount cams |
| 22. | Rotary cams |
| 23. | Die Springs |
| 24. | Fiber-belted rubber springs |
| 25. | Urethane springs |
| 26. | Nitrogen gas springs |
| 27. | Nitrogen manifolds |
| 28. | Nitrogen plated systems |
| 29. | Nitrogen hybrid manifold / plate |
| | systems |
| 30. | Tapping units |
| 31. | Rotary-action benders |
| 32. | Transfer finger devices |
| 33. | Automotive weld tools |
| 34. | Checking fixtures |
| 35. | Progressive dies |
| 36. | Transfer dies |
| 37. | Line dies |
| 38. | Draw dies |
| 39. | Trim dies |
| 40. | Pierce dies |
| 41. | Form dies |
| 42. | Flange dies |
| 43. | Cam dies |
| 44. | Container bodymaker tool packs |
| 45. | Container cupper dies |
| 46. | Wear plates |
| 47. | Gib plates |
| 48. | Keeper plates |
| 49. | Guide blocks |
| 50. | Spool retainers |
| 51. | Guide pins |
| 52. | Guide bushings |
| 53. | Ball cage guide post assemblies |
| 54. | Air cylinders |
| 55. | Retainer pins |
| 56. | Mold bases |
| 57. | Core pins |
| 58. | Injection molds |
| 59. | Transfer fingers |
| 60. | Coil lubricators |
| 61. | Servo motors |
| 62. | Screws and other threaded fasteners |
| 63. | Dowels |
| 64. | Thrust keys |
| 65. | Tooling materials |
| 66. | Coil feeders |
| 67. | Sheet feeders |
| 68. | Sensors |
| 69. | Conveyors |
| 70. | Uncoilers |
| 71. | Rewinders |
| 72. | Scrap choppers |
| 73. | Mechanical gap presses |
| 74. | Mechanical straight side presses |
| 75. | Mechanical transfer presses |
| 76. | Closet organizers |
| 77. | Garage organizers |
| 78. | Refrigerators |
| 79. | Stoves |
| 80. | Microwave ovens |
| 81. | Clothes washers |
| 82. | Clothes dryers |
| 83. | Tailored shoes |
| 84. | Tailored shirts |
| 85. | Tailored suit jackets |
| 86. | Tailored pants |
| 87. | Tailored dresses |
| 88. | Playground equipment |
| 89. | Automotive tires |
| 90. | Cooking utensils |
| 91. | Eating utensils |
| 92. | Televisions |
| 93. | Audio equipment |
| 94. | Computers |
| 95. | Video recorders |
| 96. | DVD / video players |
| 97. | Cameras |
| 98. | Mobile telephones |
| 99. | Cookware |
| 100. | Dishwashers |
| 101. | Hydraulic straight side presses |
| 102. | Markers and identification stamps |
| 103. | Die and press safety blocks |
| 104. | Stop blocks |
| 105. | Die handling devices |
| 106. | Tooling clamps |
| 107. | Stitch tooling |
| 108. | Scrap flippers |
| 109. | Scrap chutes |
| 110. | Ground shafting |
| 111. | Bearings-rotary and linear |
| 112. | Blank dies |
| 113. | Weld fixtures |
| 114. | CMM inspection fixtures |
| 115. | Surface treatments for tool steels |
| 116. | Pneumatic fittings and hoses |
| 117. | Hobbyist projects (robots, custom |
| | computers, etc.) |

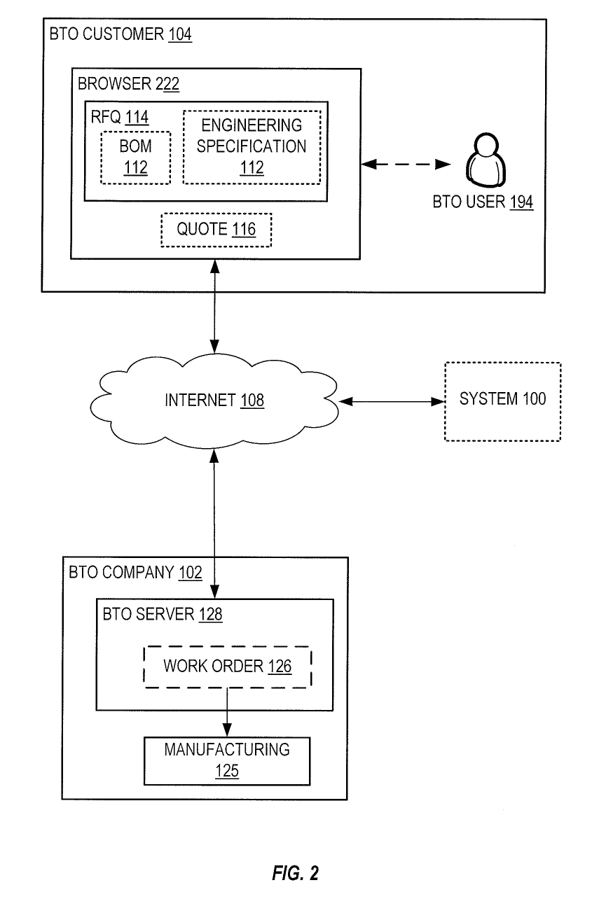

FIG. 2 shows an alternate system configuration where BTO user 194 is a representative or employee of BTO customer 104. In this embodiment, BTO user 194 interacts with browser 222 to enter RFQ 114 information directly to system 100. The entered RFQ 114 is validated during interaction by BTO user 194 and a quote is generated. Optionally, the quote is not returned to user 120 until approved by BTO company 102. In the example of FIG. 2, BTO user 194 accesses a BTO server 128 of BTO company 102 to enter information of RFQ 114. BTO server 128 is configured to allow BTO user 194 to access system 100 indirectly. That is, front-end application 155 of system 100 is configured to appear as a web site of BTO company 102 such that user 194 is unaware that they are accessing system 100; user 194 is aware only that BTO company 102 includes functionality of system 100. System 100 may support multiple BTO companies in this manner, each BTO company operating independently from each other.

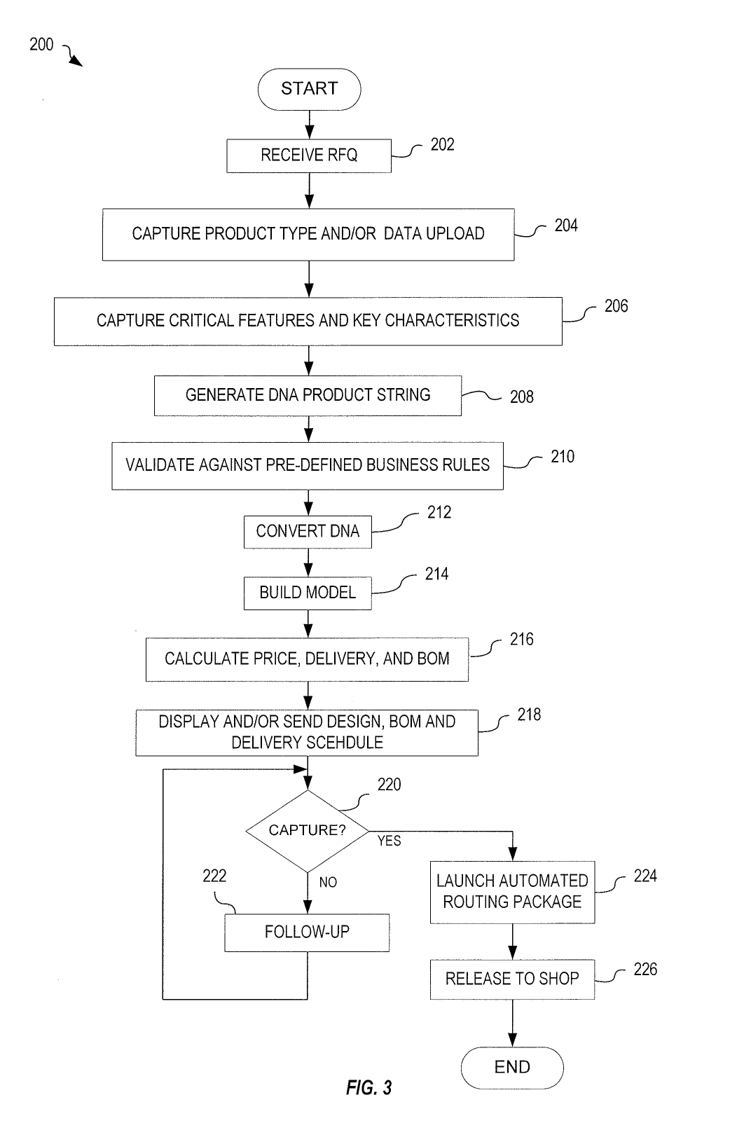

FIG. 3 is a flowchart illustrating one example of a process 200 for automating engineering transaction processes for BTO projects. Step 202 of process 200 may occur within BTO company 102. Steps 204-218 of process 200 may occur within system 100 of FIGS. 1 and 2. Steps 220-226 may occur within system 100 and/or BTO company 102.

In step 202, process 200 receives an RFQ from a potential customer. In one example of step 202, BTO company 102 receives RFQ 114 from BTO customer 104 via internet 108. In step 204, process 200 captures a product type and other information. In one example of step 204, BTO user 120 interactively enters information of RFQ 114 to system 100 via browser 122, internet 108 and front-end application 155. In another example of step 204, user 194 uploads design files of RFQ 114 to system 100.

In step 206, process 200 captures critical features and key characteristics of RFQ 114. In one example of step 206, BTO user 120 enters a starting brand and/or defines a product type and defining features and/or characteristics of BTO product 105. In step 208, process 200 generates a DNA product string based upon information captured in step 204 and 206. In one example of step 208, engine 160 of system 100 generates DNA product string 167 based upon information of RFQ 154 entered in steps 204 and 206. In step 210, process 200 validates captured information and models against one or more business rules. In one example of step 210, DNA product string 167 and BTO user 120 inputs are validated against business rules 171. In step 212, process 200 converts the DNA product string into one or more desired brand part numbers. In one example of step 212, engine 160 converts DNA product string 167 into a brand selected by BTO company 102.

In step 214, process 200 builds a solid model of the product based upon the DNA product string. In one example of step 214, engine 160 controls model generator 165 to generate operators or instructions 166 for modeler 180 to generate model 152 of BTO product 105 based upon DNA product string 167. In step 216, process 200 calculates price, delivery, and BOM of the BTO product. In one example of step 216, engine 160 controls estimator 162 to evaluate model 152 to determine product specific information (e.g., mass property data, weight, center of mass, etc.). Estimator 162 then matches the calculated product specific information with business rules 171 to determine a price, delivery times, and a BOM for BTO product 105.

In step 218, process 200 displays and/or sends the design, BOM, and delivery schedule to the user. In one example of step 218, system 100 displays model view 152, BOM and delivery schedule to BTO user 120 via web browser 122, internet 108 and front-end application 155. BTO user 120 may then send quote 156 to BTO customer 104.

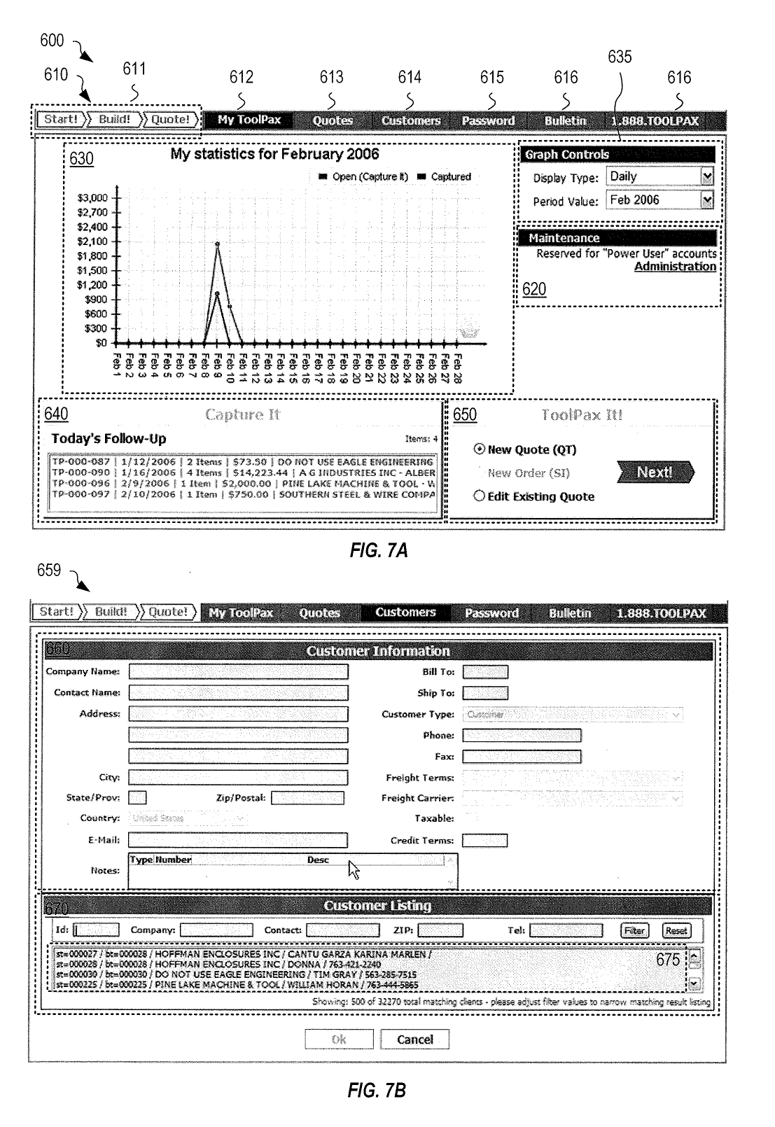

Step 220 is a decision. If, in step 220, process 200 determines that the customer has accepted the quote and placed an order, process 200 continues with step 224; otherwise process 200 continues with step 222. In one example of step 220, BTO customer 104 evaluates quote 116 and contacts BTO company 102 to place an order for BTO product 105; BTO user 120 then enters acceptance of quote 116 into system 100. In step 222, process 200 generates one or more follow-up reminders. In one example of step 222, system 100 generates and sends emails and/or other notifications to BTO user 120, thereby reminding user 120 to contact BTO customer 104 regarding quote 116. Steps 220 and 222 repeat periodically until the order for quote 116 is captured or cancelled by BTO company 102. Delivery time and pricing information may also be updated based on follow-up timing. See the screen shot of a follow-up pane 640 shown in FIG. 7A as an example of this process.

In step 224, process 200 launches automated routing. In one example of step 224, system 100 generates work order 126 for BTO company 102 based upon quote 156 and model 152. In step 226, process 200 releases the BTO product for manufacture. In one example of step 226, BTO product 105 as specified by DNA product string 167 is released to manufacture 125.

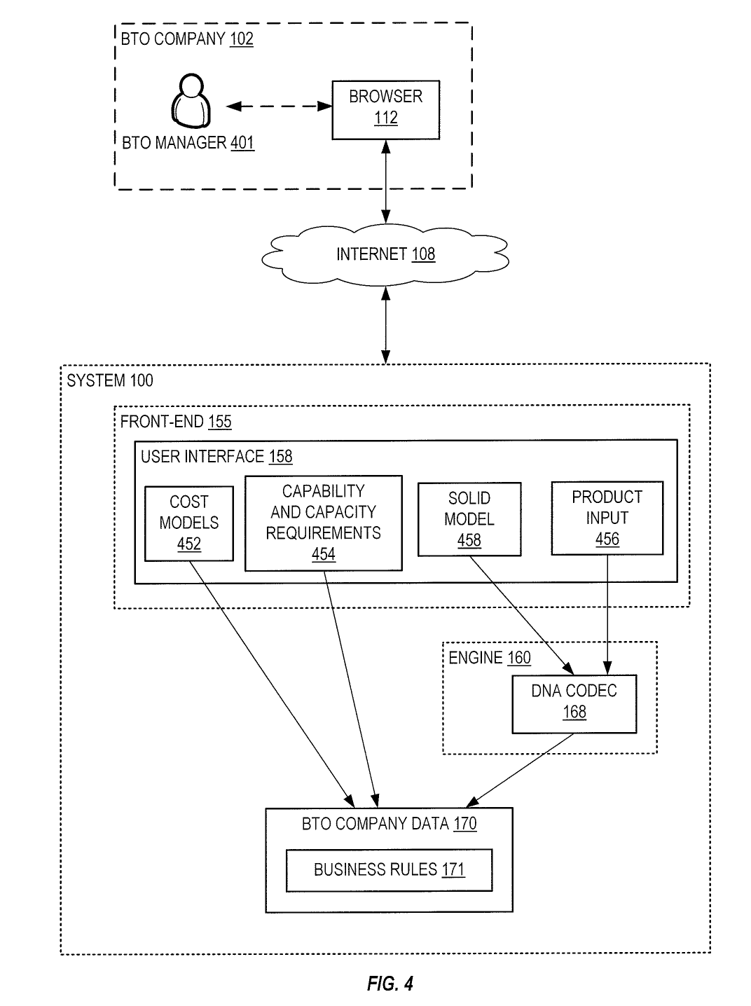

FIG. 4 shows additional functionality of system 100 for maintaining BTO company data 170. A BTO manager 401 of BTO company 102 utilizes browser 112 (or another browser) to access system 100 via internet 108. In particular, manager 401 interacts with front-end application 155 to create one or more of cost models 452, capability and capacity requirements 454, solid models 458, and product (information) input 456. Product input 456 specifies standard products and components manufactured by BTO company 102. Manager 401 may interactively use model generator 165 to create solid models 458 of specified products and components 456. Manager 401 may also create one or more business rules 171 for use by engine 160 and estimator 162 of FIG. 1. Business rules 171, cost models 452, capability and capacity limitations 454 and product input 456 are stored within BTO company data 170 for use by engine 160 when evaluating RFQ 154.

FIGS. 7-15 are examples of screen shots of interactive web pages generated by user interface 158 during interaction with user 120. An explorer bar 610 allows BTO user 120 to easily navigate options and functionality of system 100. Many of these exemplary screen shots includes an explorer bar 610 with a status pane 611 and tabs 612-617. Status pane 611 provides a visual indication to BTO user 120 of progress through a quoting cycle. For example, when BTO user 120 starts a new quote, the Start! indicator is highlighted in status panel 611. Tabs 612-617 allow BTO user 120 to quickly navigate through commonly used screens of user interface 158. For example, a home tab 612, shown as “My Toolpax” in FIG. 7A, allows BTO user 120 to quickly return to the screen shot of FIG. 7A which is the home page of user interface 158. Quotes tab 613 allows BTO user 120 to switch to a screen for viewing pending quotes of BTO customers (e.g. BTO customer 104). Other tabs 614, 615, 616, and 617, allow BTO user 120 to switch to a customers screen, a password screen, a bulletin screen and a contacts link screen, respectively.

In particular, FIG. 7A illustrates an example of a screen shot of a ‘home’ page 600 of user interface 158 and has several panels that allow BTO user 120 to view and enter information. Home page 600 has a statistics panel 630 for displaying statistics of BTO company 102 graphically. The display of statistics is based upon selected settings of a graph control panel 635, also on home page 600. Home page 600 also has a capture panel 640 that displays follow-up information to prompt BTO user 120 of up-coming events, such as a reminder to follow-up on quote 116, FIG. 1, for which an order has not yet been placed. Home page 600 also has a quote panel 650, (shown with a title of “ToolPax It!”) that allows BTO user 120 to start a new quote or to modify an existing quote. Home page 600 is also shown with a maintenance panel 620 that is reserved for “Power User” accounts and allows a system administrator access to certain restricted areas of user interface 158 (e.g., to maintain certain data of BTO company 102 within system 100).

FIG. 7B illustrates an example of a customer mode screen 659. BTO user 120 may enter customer information screen 659 by selecting customer tab 614 from any screen that displays toolbar 610. Customer mode screen 659 has a customer information panel 660 that allows BTO user 120 to enter new customer information, such as company name, contact name, contact information, email address, shipping address, billing address, phone, etc., in this example. Existing customer information may be accessed by selecting one company from a selection box 675 of a customer listing pane 670.

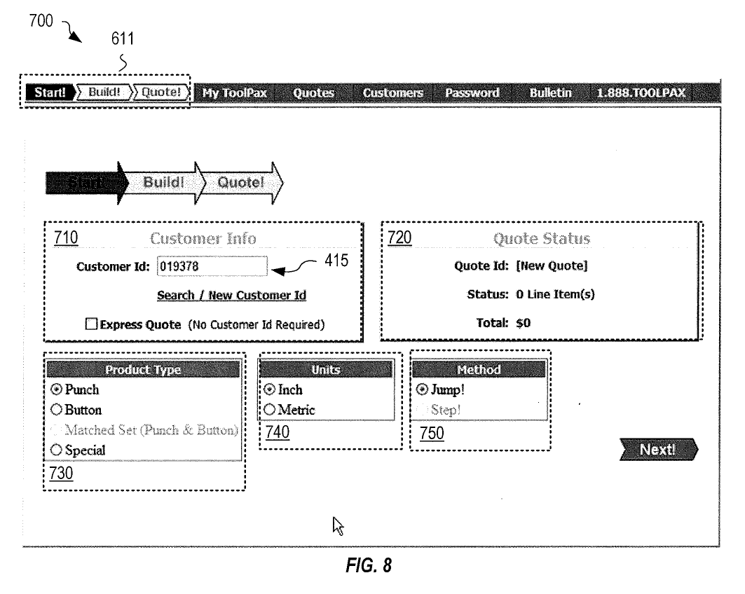

FIG. 8 shows one example of a new quote page 700 for starting a new quote (i.e., for entering information of RFQ 114 of FIG. 1). New quote page 700 shows status bar 611 in which the Start! indicator is highlighted. New quote page 700 also includes a customer information panel 710 that allows BTO user 120 to enter a customer ID or select an express quote option that allows a quote to be generated without a customer ID. New quote page 700 also includes a quote status panel 720 that shows the current status of the quote including: quote id; number of items; total price; etc. New quote page 700 also has a product type panel 730, a units panel 740 and a method panel 750. BTO user 120 may select a radio button within product type panel 730 to choose the type of product to be quoted. In the example shown, BTO user can select from: Punch; Button; Matched Set (Punch & Button); or Special. Unit panel 740 allows BTO user 120 to select a desired measurement system. Method panel 750 allows BTO user 120 to choose between Jump! and Step! methods. In the example of FIG. 8, BTO user 120 has entered customer Id 019378 into a Customer Id field 715 of Customer Information panel 710.

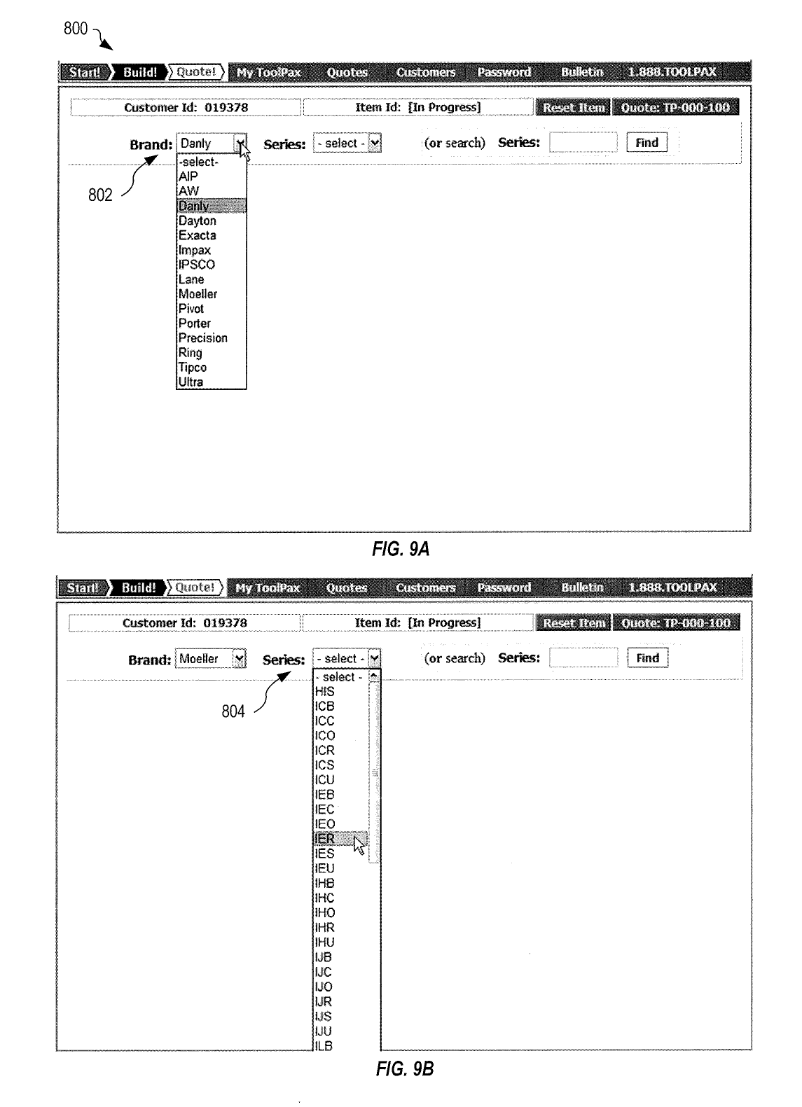

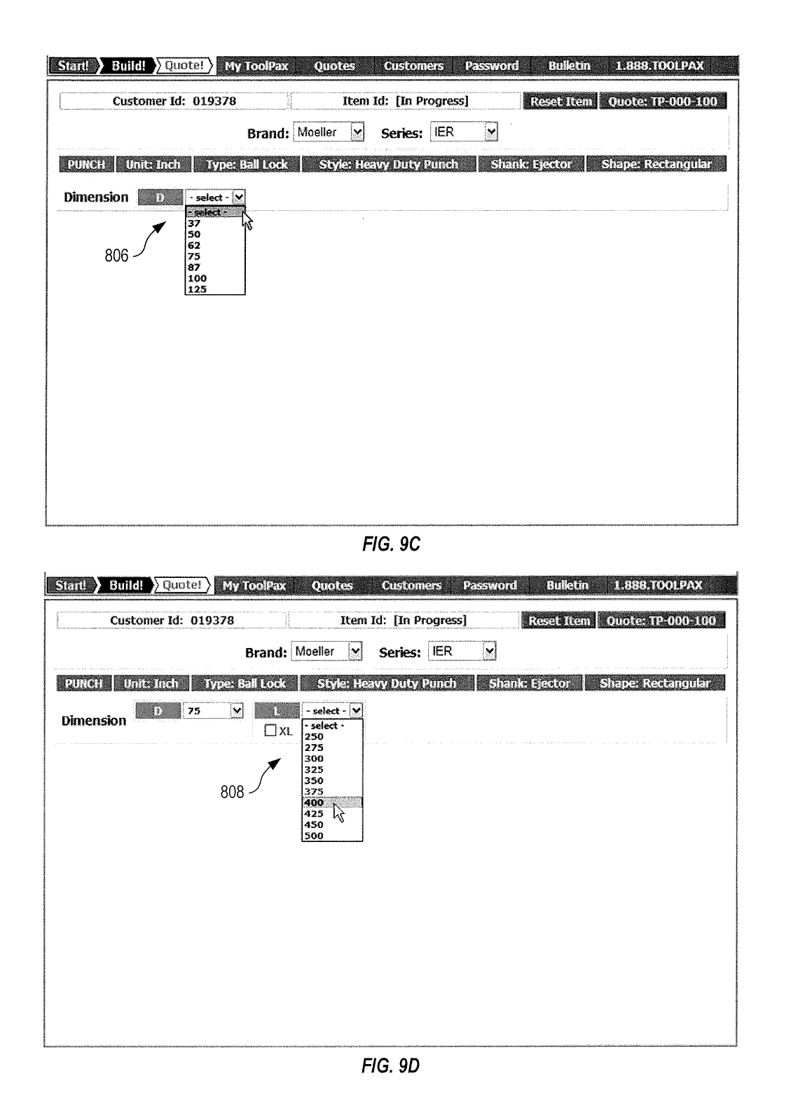

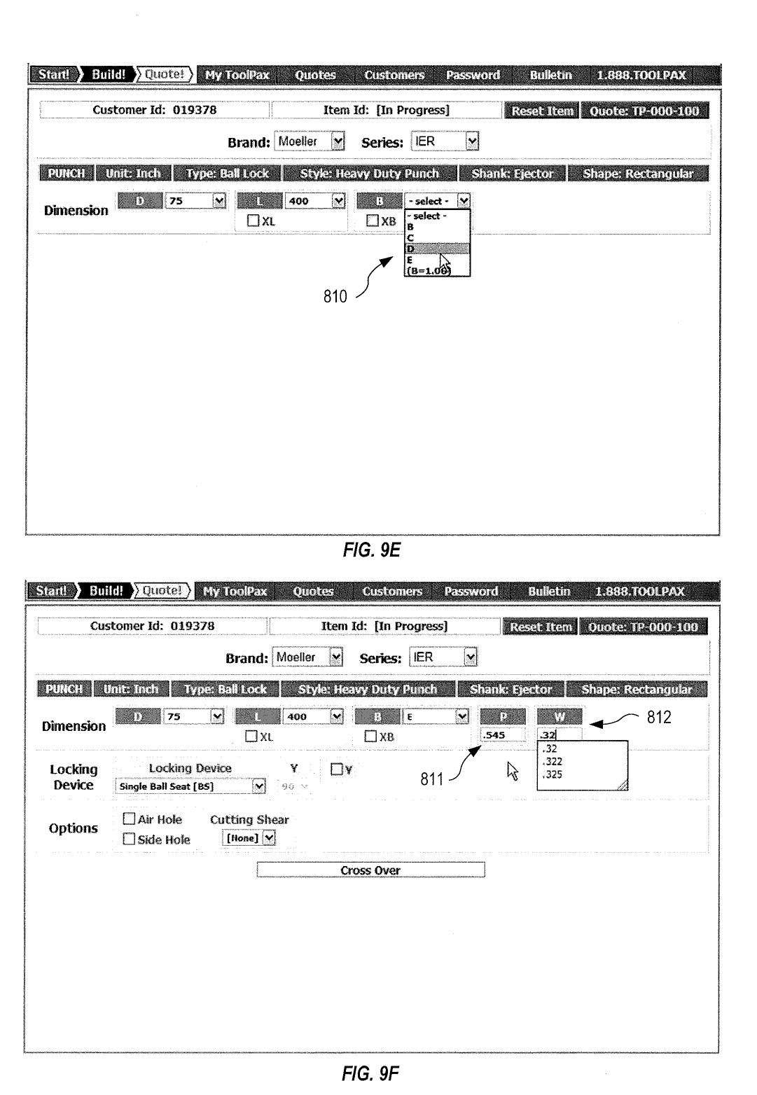

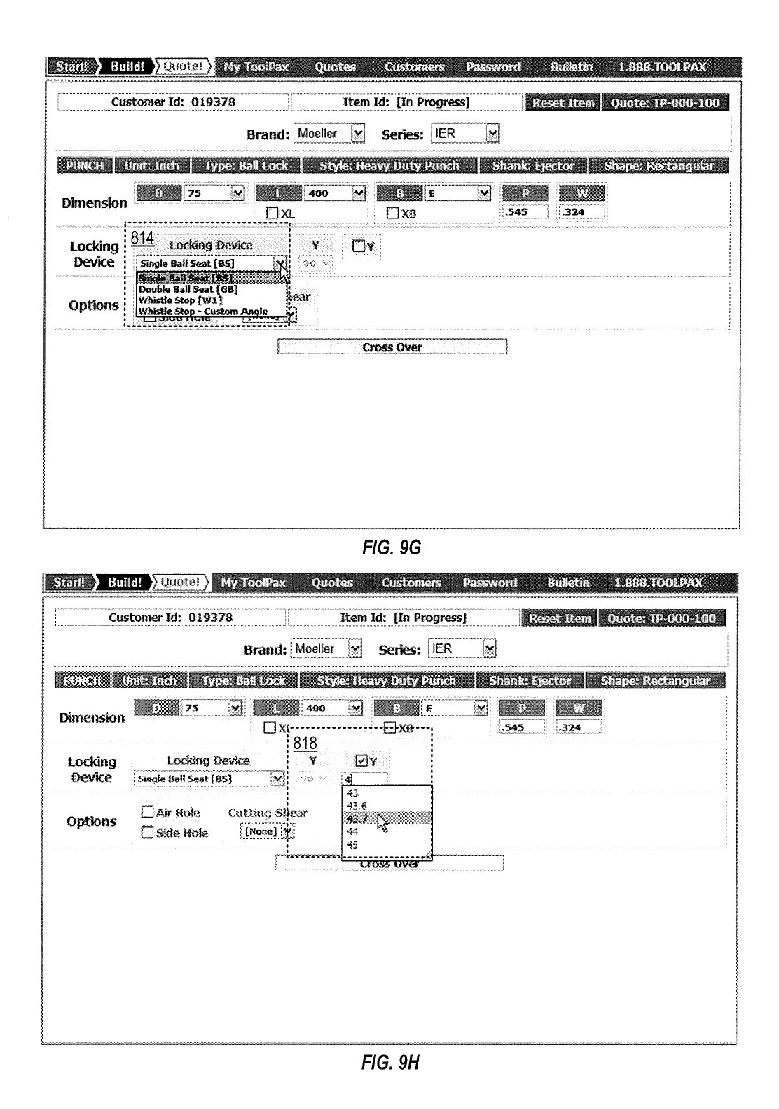

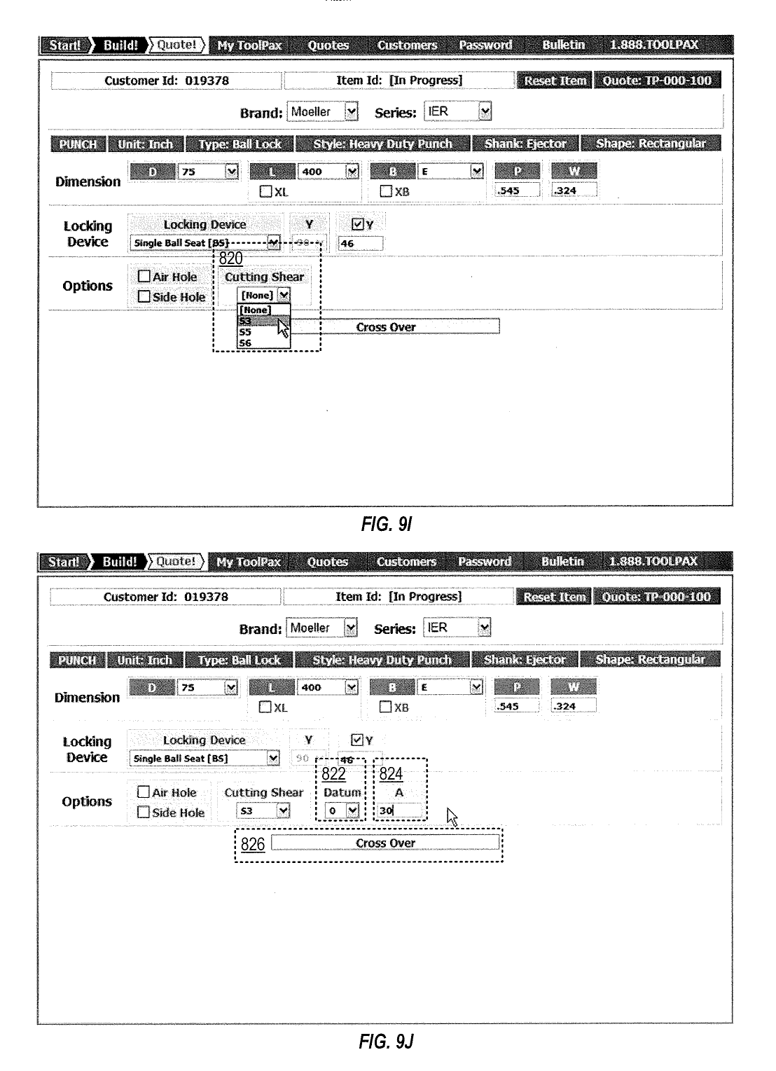

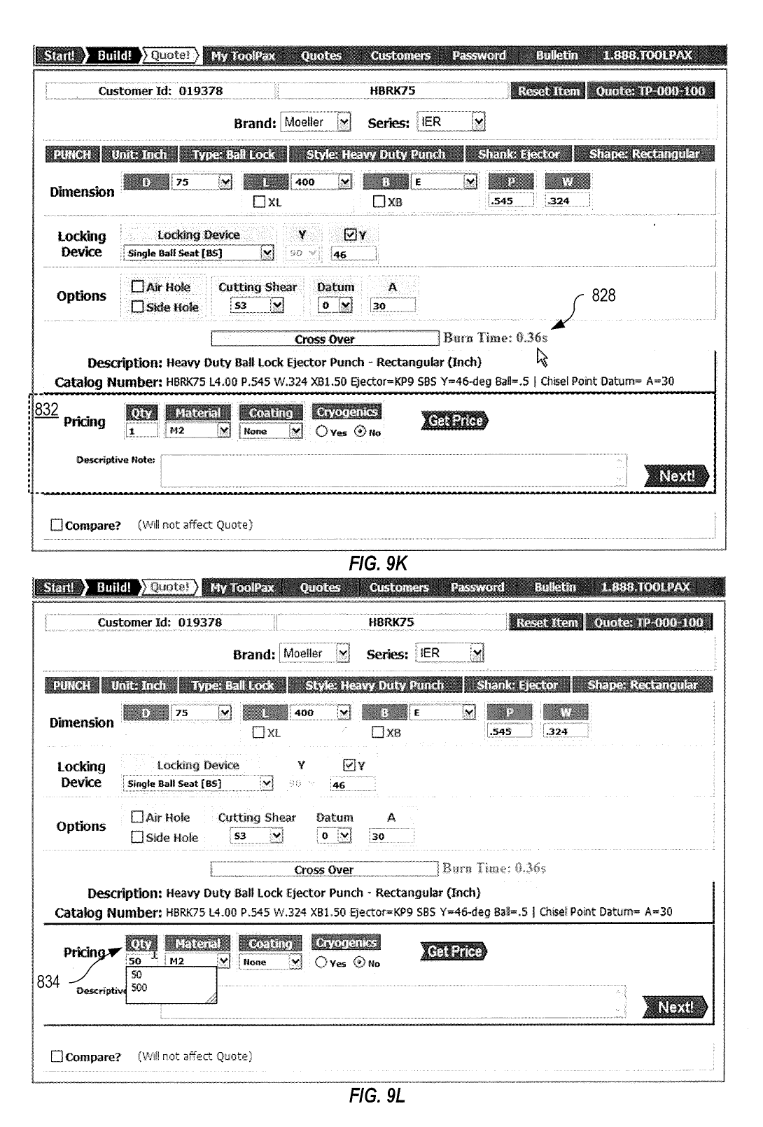

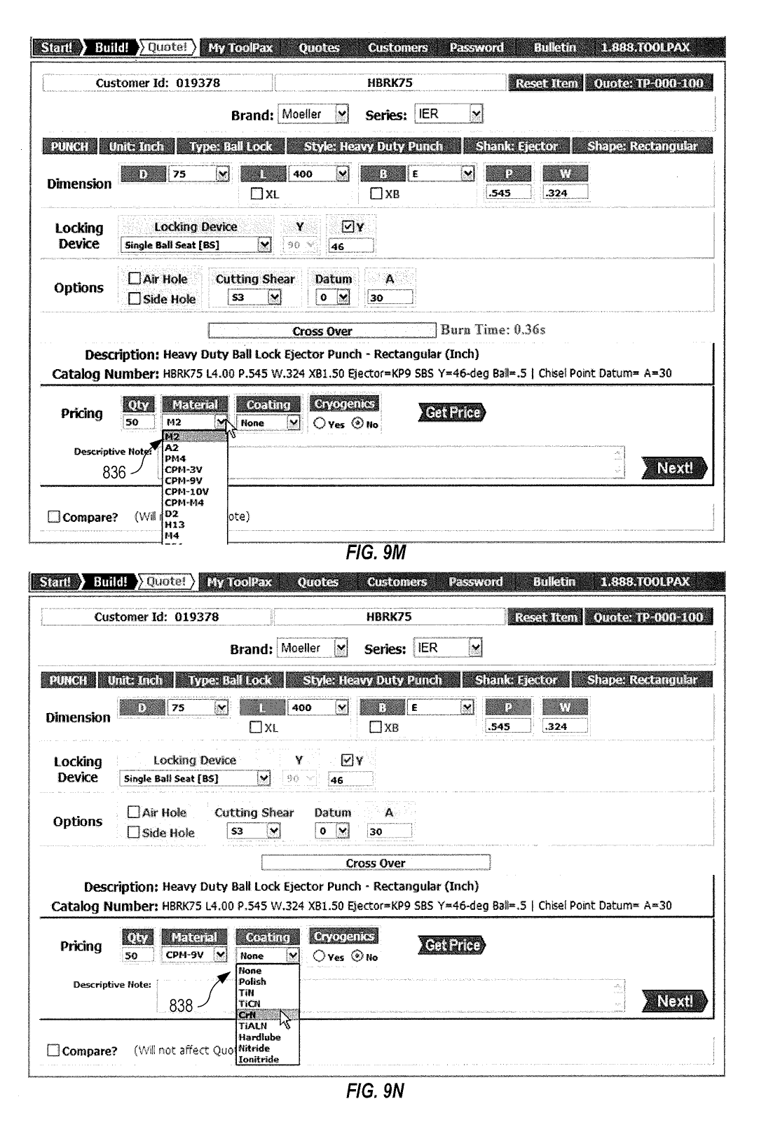

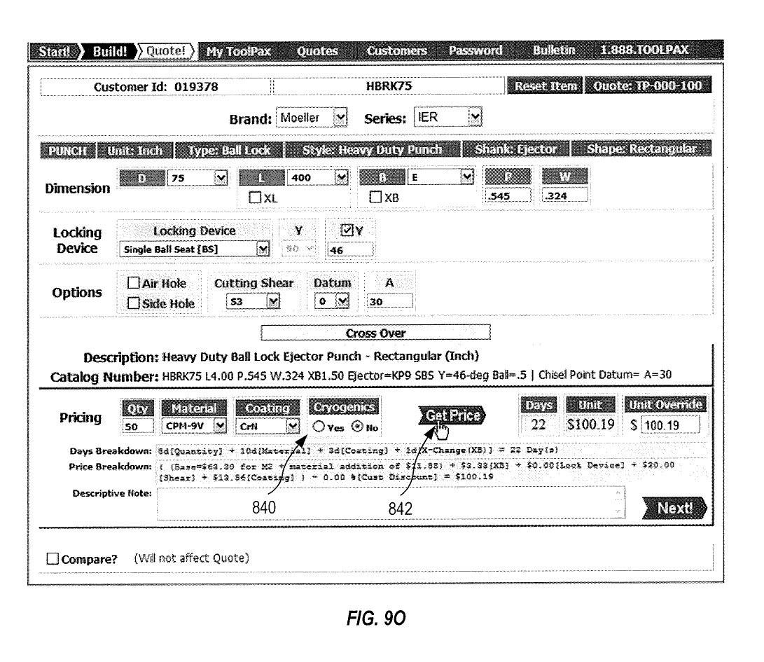

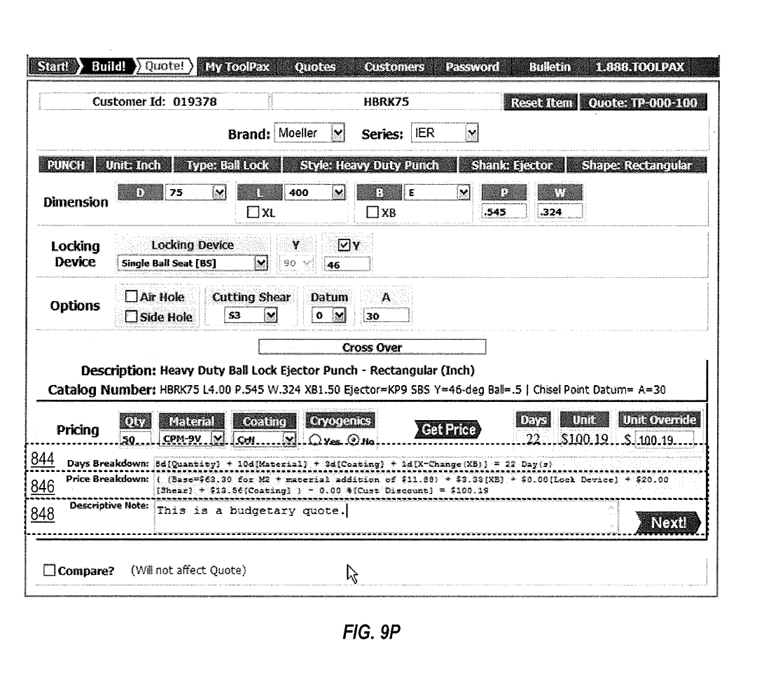

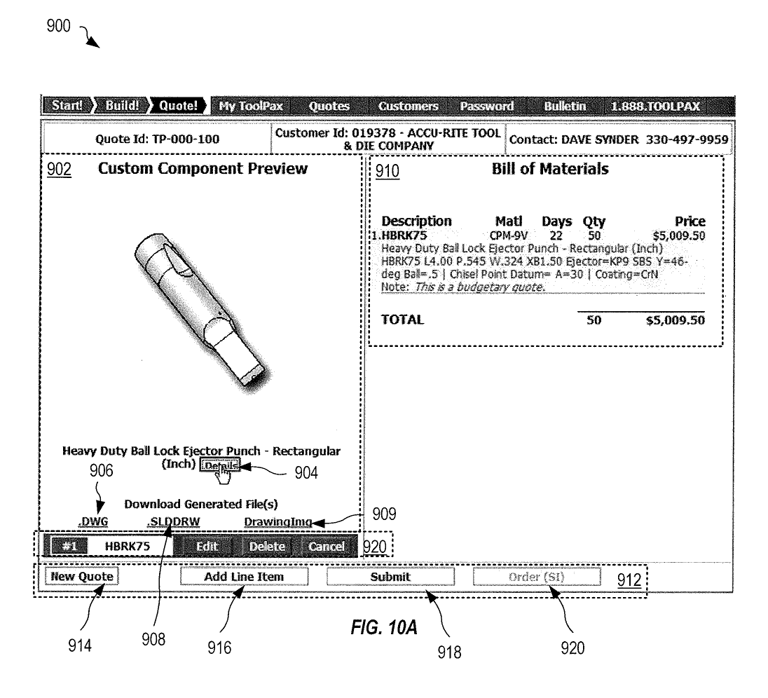

FIGS. 9A-9P are screen shots illustrating examples of steps of entering information of die hole punching components during the build cycle of the quote entry process. FIG. 9A shows a brand selected from a drop down list 802 of die hole punching component manufacturers. FIG. 9B shows a product series selected from a drop down list 804. Optionally BTO user 120 may enter characters to search for possible matches. FIGS. 9C-9F show how component dimensions of the punch are selected. As shown in each of these screen shots, once a selection is made, a next possible selection is displayed. For example, once BTO user 120 selects the dimension in panel D 806, FIG. 9C, a new panel dimension L 808 appears as shown in FIG. 9D. Once BTO user 120 selects the dimension in panel L 808, a new dimension in panel B 810 appears. After the dimension in panel B 810 (as shown in FIG. 9E) has been selected from a drop down menu, dimension panels P and W require BTO user 120 to enter the dimensions accordingly (shown in FIG. 9F).

As shown in FIGS. 9G and 9H, BTO user 120 selects a locking device and parameters. BTO user 120 first selects the locking device from the locking device panel 814 drop down menu. Locking device panel options may include: single ball seat; double ball seat; whistle stop; and whistle stop (custom angle). As shown in FIG. 9H, BTO user 120 selects an angle from a Y panel 818 drop down menu. As shown in FIGS. 9I and 9J, other component options are selected by BTO user 120. FIG. 9I shows selection of a cutting shear from a cutting shear panel 820. Once an option is selected in cutting shear panel 820, a datum panel 822 and “A” panel 624 become visible to allow BTO user 120 to enter values. After completion, BTO user 120 activates crossover button 826.

As shown in FIG. 9K, the burn time 828 is displayed in seconds along with the product description and catalog number. A pricing panel 832 allows BTO user 120 to enter quantity 834, material 836, coating 838, and cryogenics 840, as shown in FIGS. 9L-9N. BTO user 120 may then select a price button 842, shown in FIG. 90 as “Get Price”, to cause ‘day breakdown’ panel 844 and ‘price breakdown’ panel 846 to appear. Day breakdown panel 844 may display the breakdown of days required to manufacture the product based on quantity, material, coating, etc. Price breakdown panel 846 may display the price breakdown based on base price, additional material, manufacturing options, shear, coating, etc. Additionally, the price breakdown may be reduced by a specified percentage based on a customer discount. FIG. 9P shows descriptive note panel 848. BTO user 120 may enter textual message in this area for communication to BTO customer 104 or other BTO user(s) 120.

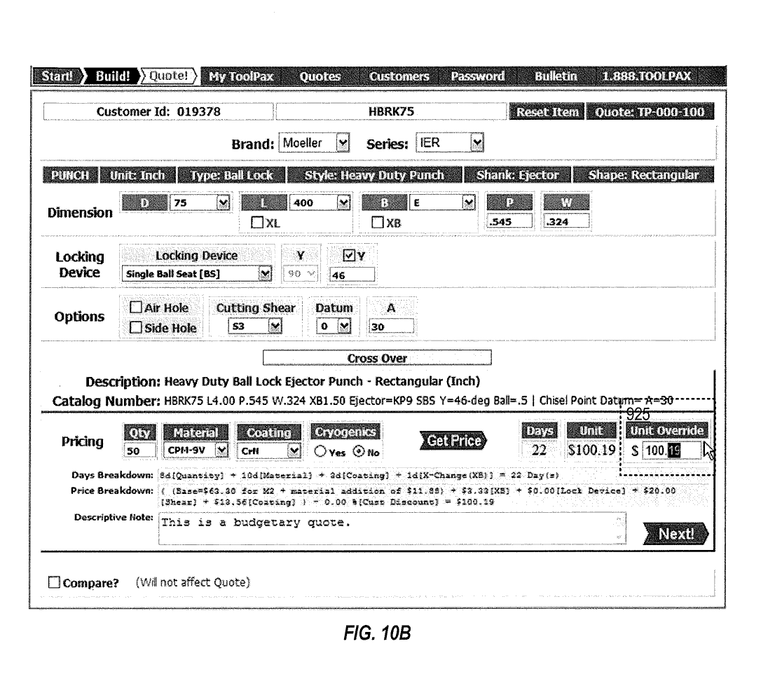

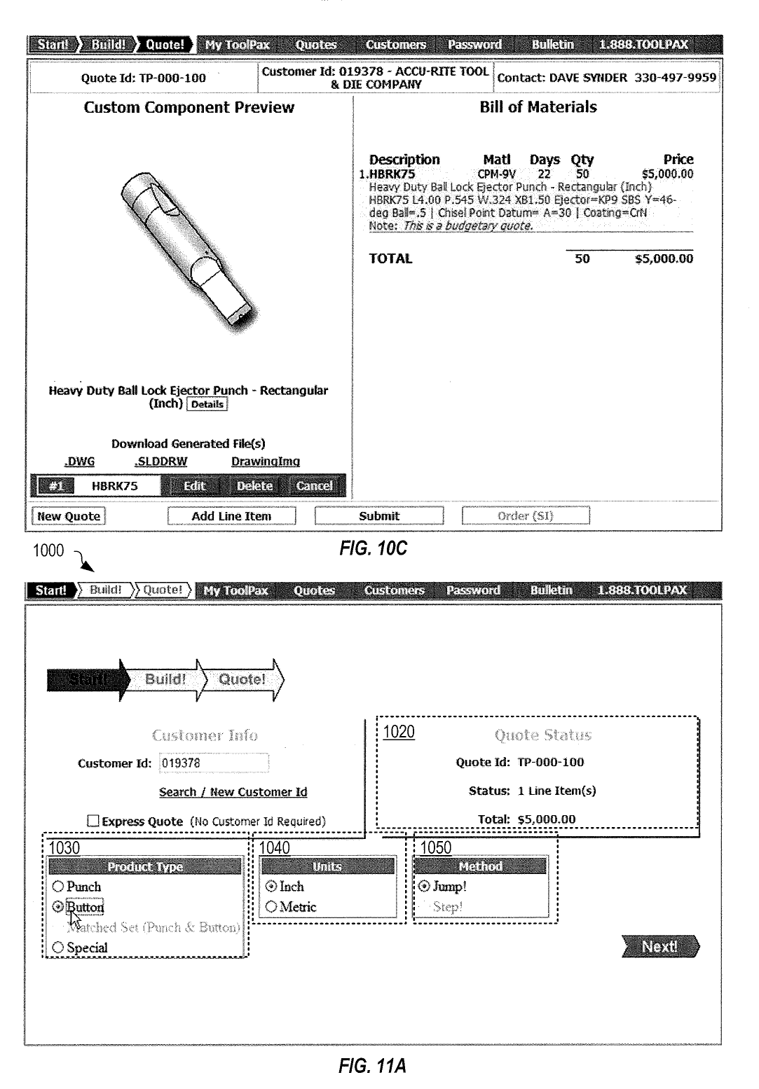

Once all information required to build the product has been entered, BTO user can then preview component and bill of material information. FIG. 10 illustrates one example of a web user interface 900 for die hole punching components during the Quote! cycle of the process. The quote bar 912 may be located at the bottom of user interface 900 during the Quote! cycle. Quote bar 912 may include buttons: new quote 914; add line item 916; submit 918; and order 920.

FIG. 10A illustrates component preview panel 902 and a bill of materials panel 910. Component preview panel 902 allows BTO user 120 to preview the component. The BTO user 120 may also get more details on the component by pressing the details button 904. Component preview panel 902 also allows a BTO user 120 to download generated files in a number of formats using hyperlinks 906, 908, and 909. This allows a BTO user 120 to view custom or altered standard product previews with hyperlinks to the digital engineering models. An image of the generated model 152, shown in FIG. 1, is embedded onto a quote form and includes a hyperlink to the engineering model. The quote and/or image may then be emailed, electronically faxed, or viewed using the web browser 122. For example, BTO user 120 may click on the image to download the engineering model. Thus, BTO user 120 obtains a fully-defined engineering model of the desired custom or altered product in real-time. Where BTO user 120 has defined the required engineering file format, the engineering model may be created and linked to the image on the RFQ response.

Bill of materials panel 910 gives a detailed description of the component including: part number; material; number of days to manufacture; quantity; and price. A component edit panel 920 allows a BTO user 120 to modify parameters of the existing component. Edit panel 920 has edit, delete, and cancel buttons. In one example, BTO user 120 may edit the component by selecting the edit button in edit panel 920. BTO user 120 would then return to the build cycle as shown in FIG. 10B. BTO user 120 may then modify any of the entered parameters. In one example, shown in FIG. 10B, the BTO user 120 can modify the price by manually adjusting the price in unit override panel 925. FIG. 10C shows the modified price.

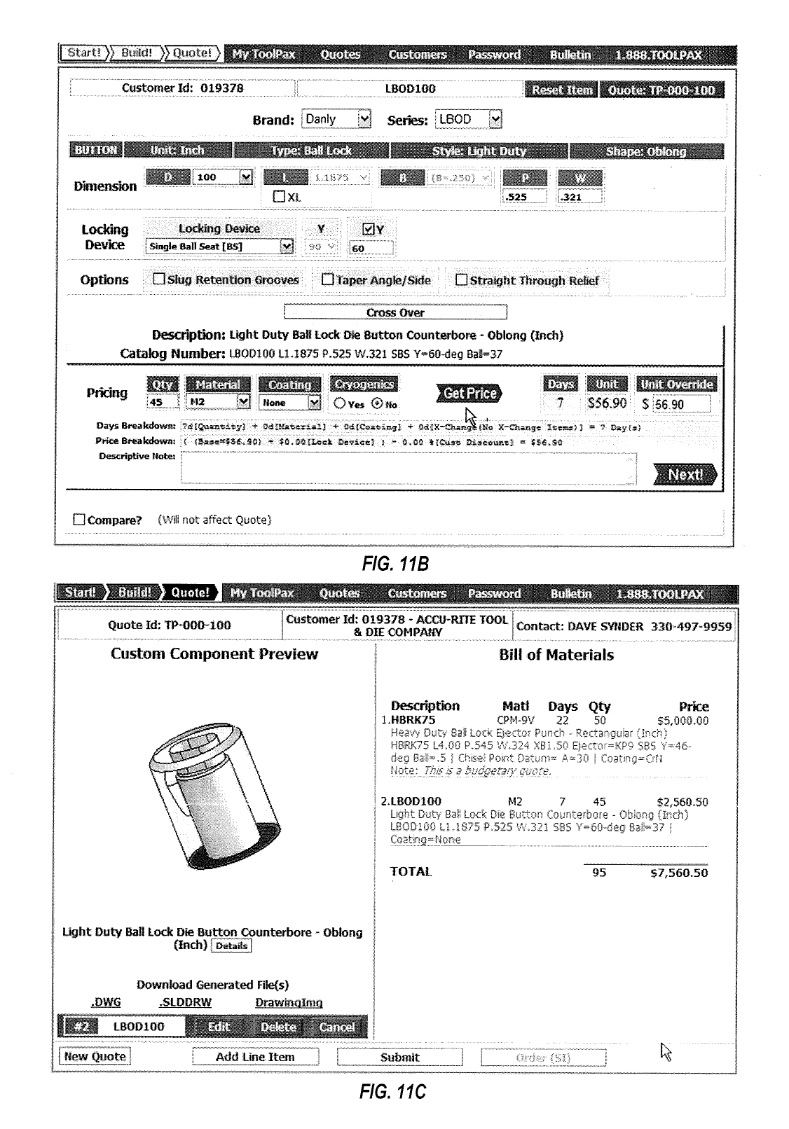

FIGS. 11A-11C illustrate examples of screen shots of web interface 1000 during the start cycle after components have been added. Quote status panel 1020 shows the quote id, status of one line item, and total (shown as “$5000” in FIG. 11). BTO user 120 may add another product by selecting the product type, measurement type, and method from the product type panel 1030, units panel 1040, and method panel 1050. BTO user 120 would then proceed by hitting the next button. As shown in FIG. 11B, all parameters have been added for the new component. FIG. 11C illustrates the updated component preview screen and bill of materials information.

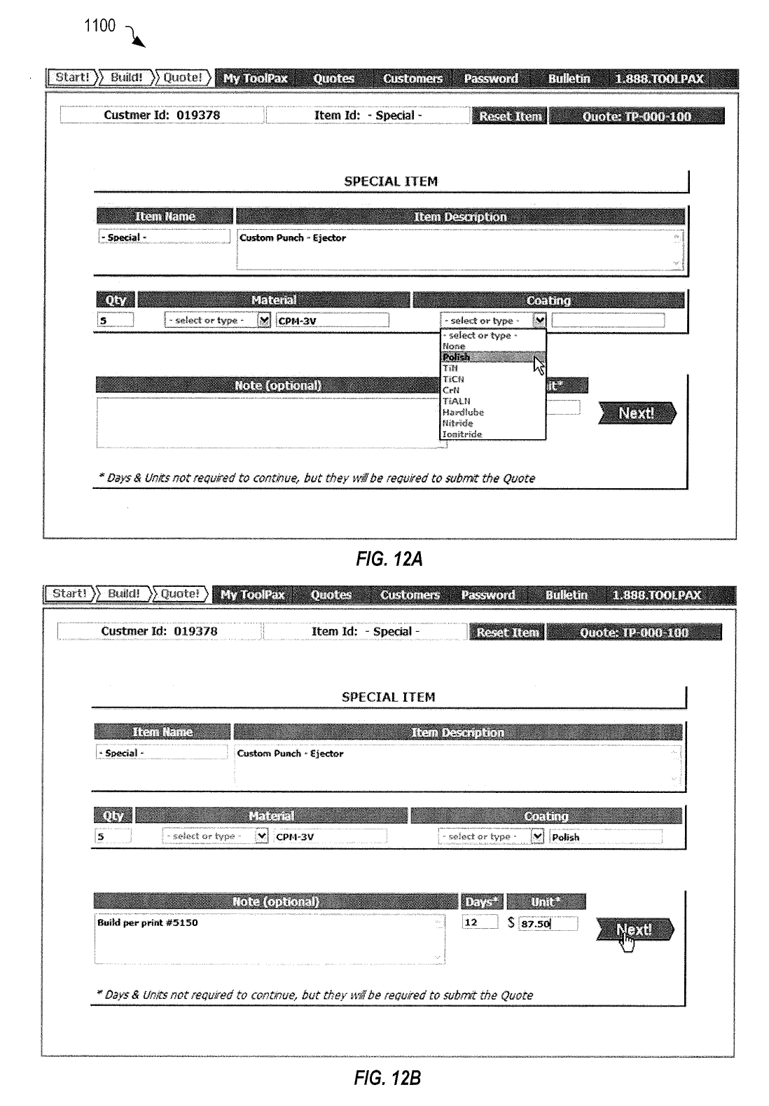

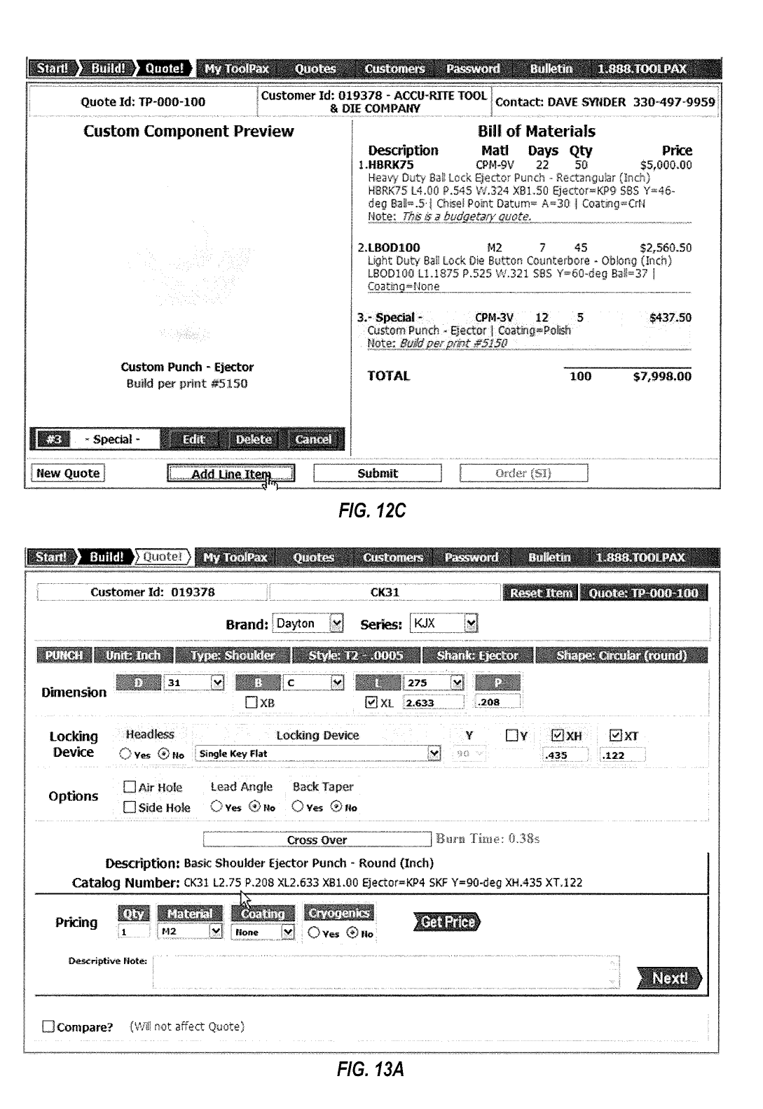

FIGS. 12A-12C shows examples of screen shots of web interface 1100 for custom die hole punching components. As shown in FIG. 12A, BTO user 120 has selected a special product type from the product type panel 1030 of FIG. 11A. BTO user 120 may then add a special custom component. FIG. 12A and FIG. 12B show the build cycle, shown as Build! in the figures, of the custom component where the BTO user 120 adds parameters and describes the custom component to be built. As shown in FIG. 12C, the components of the order can be previewed along with bill of materials. The BTO user 120 may then add another line item as shown.

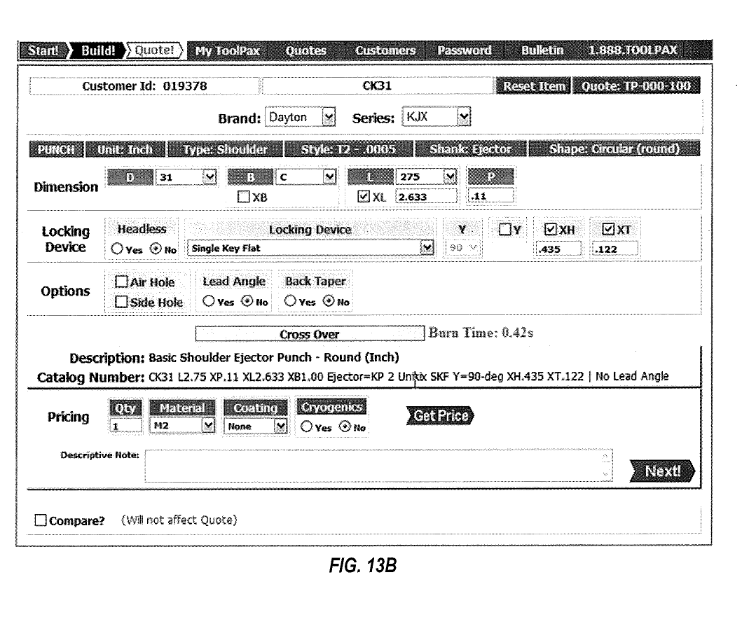

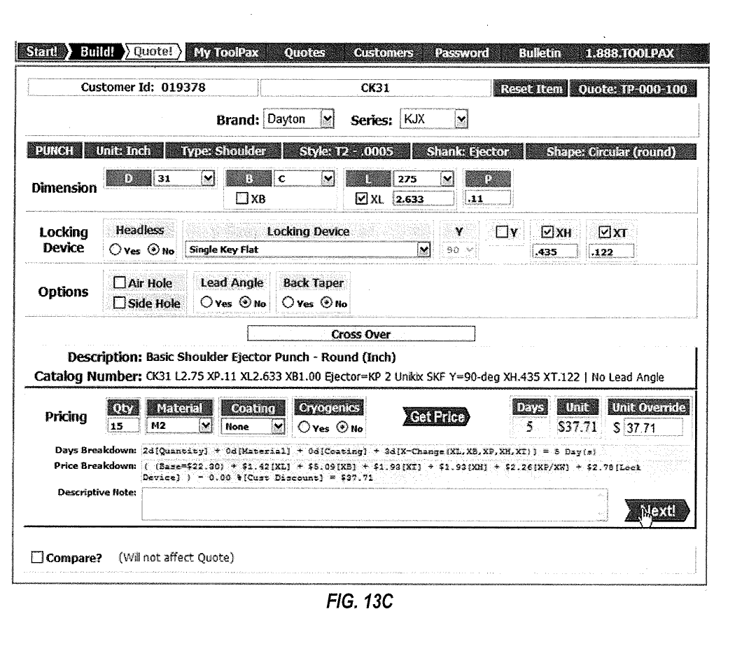

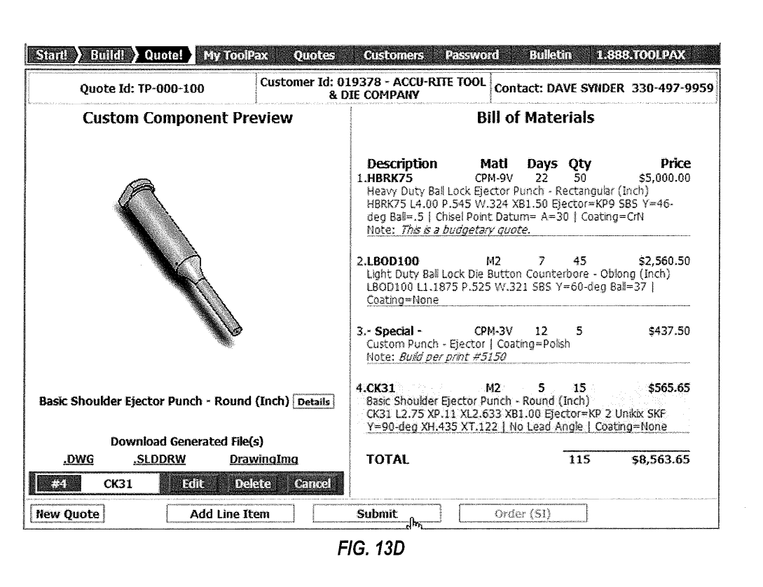

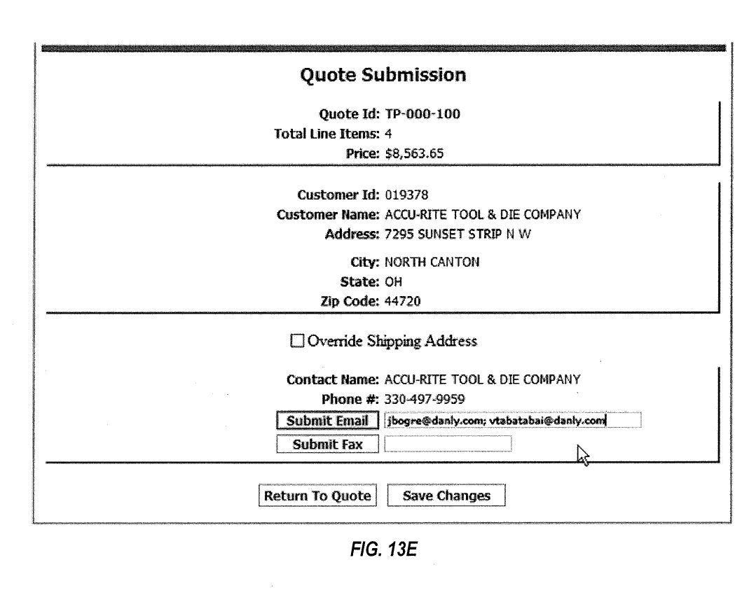

FIGS. 13A-13E illustrate the build cycle of the fourth and final component added to the current quote, shown as a basic shoulder ejector punch. As shown in FIG. 13A, FIG. 13B, and FIG. 13C, parameters are entered for the basic shoulder ejector punch. As shown in FIG. 13D, the components of the order can be previewed along with the bill of materials. If the information contained in the quote is correct, BTO user 120 may submit the quote. The quote submission page, shown in FIG. 13E, allows BTO user 120 to review address and customer information, override shipping information if necessary, submit email and/or fax to BTO customer(s) 104, and save changes to the quote for ordering when approved.

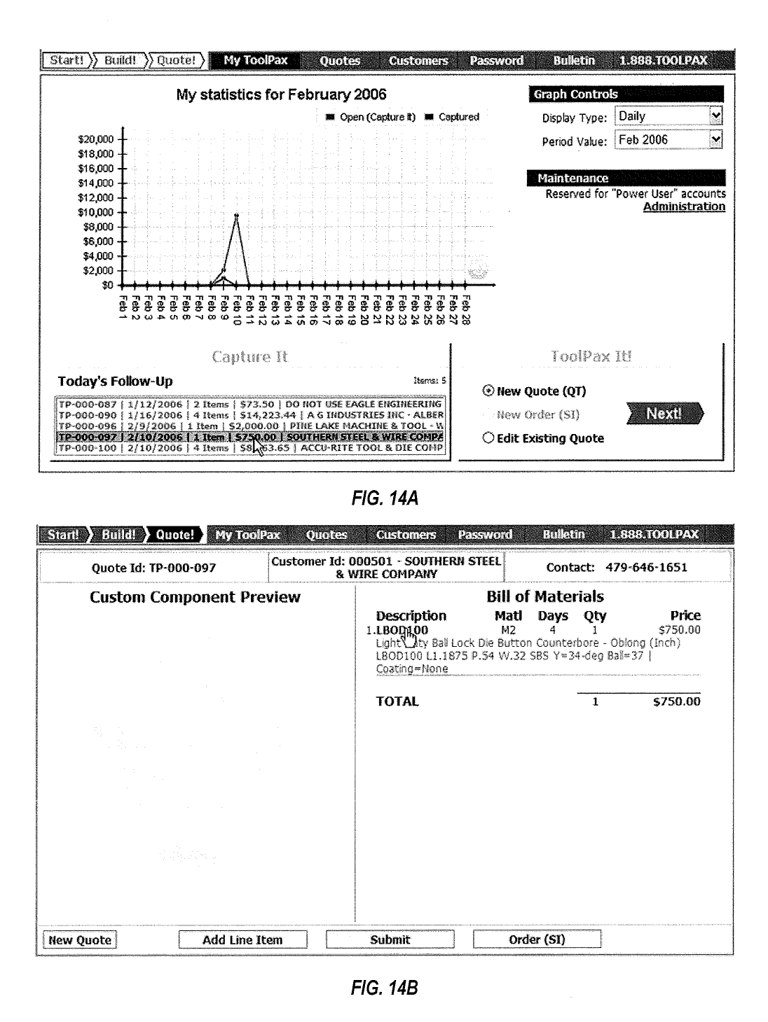

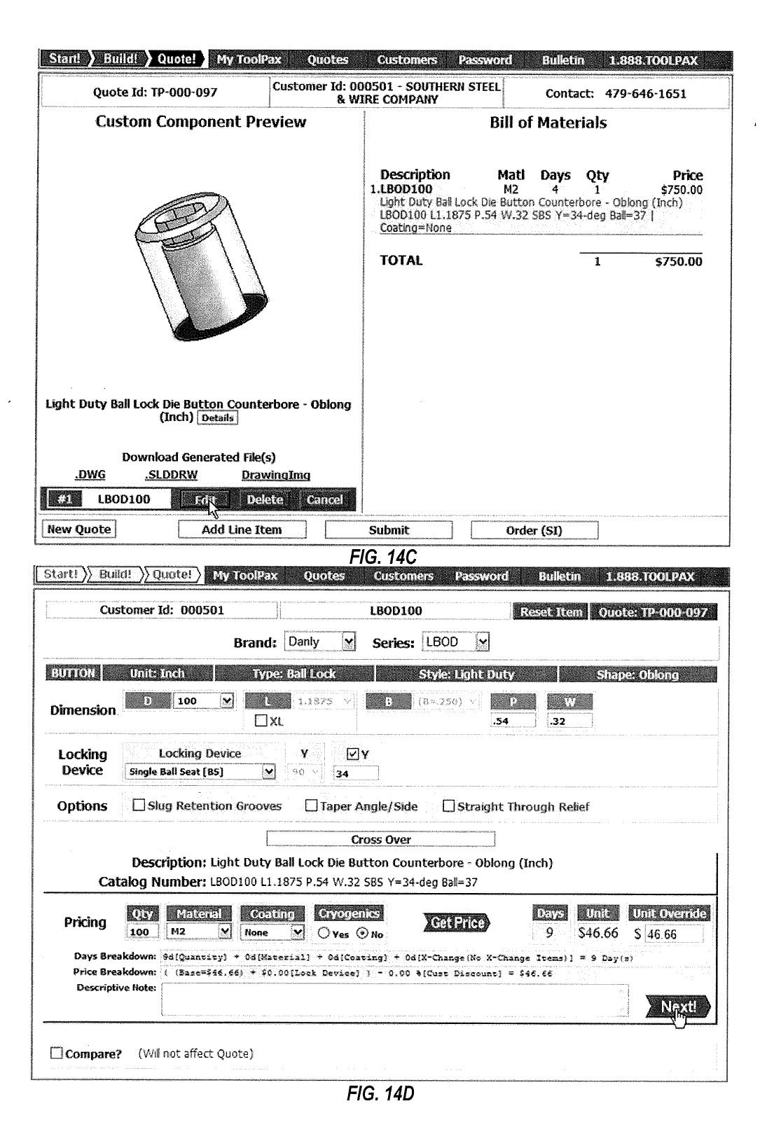

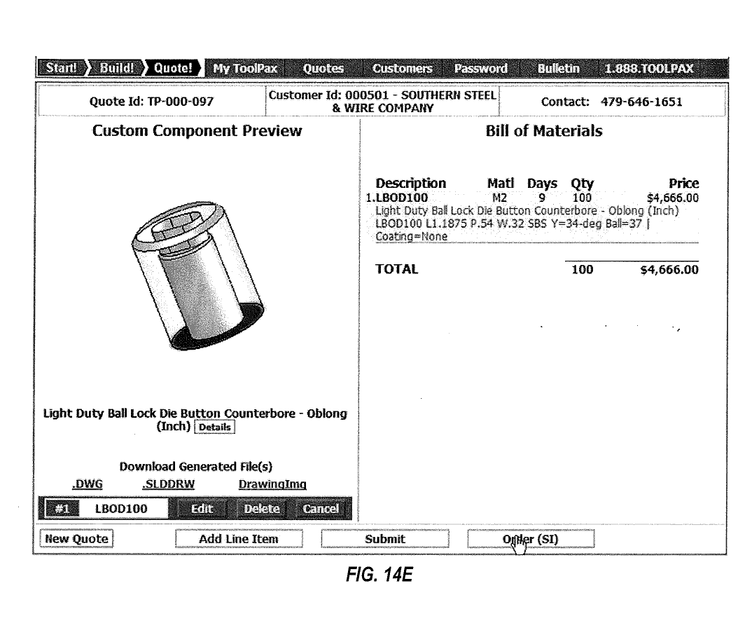

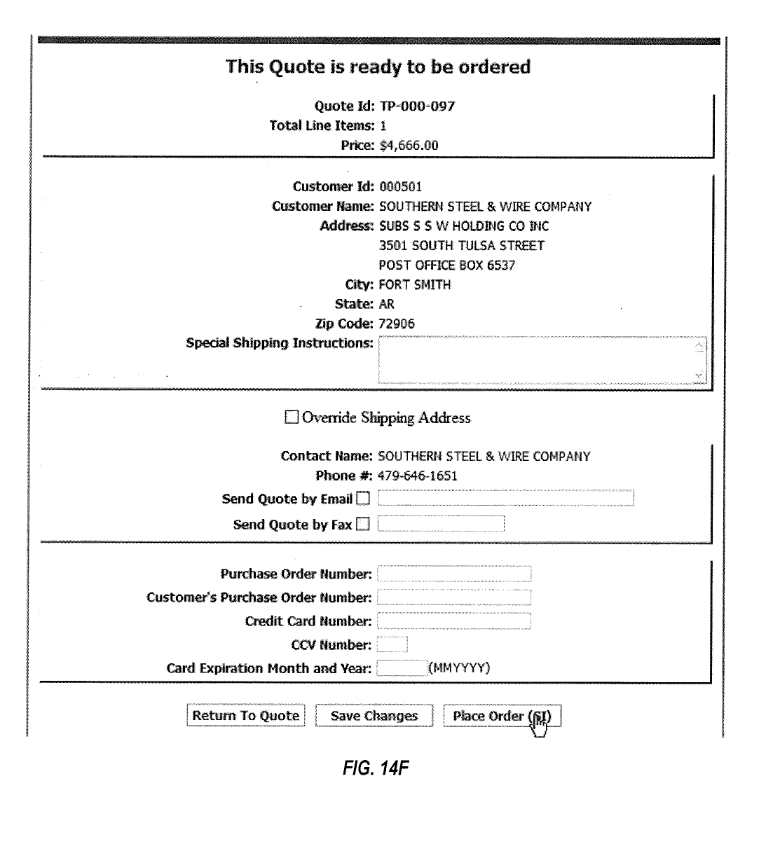

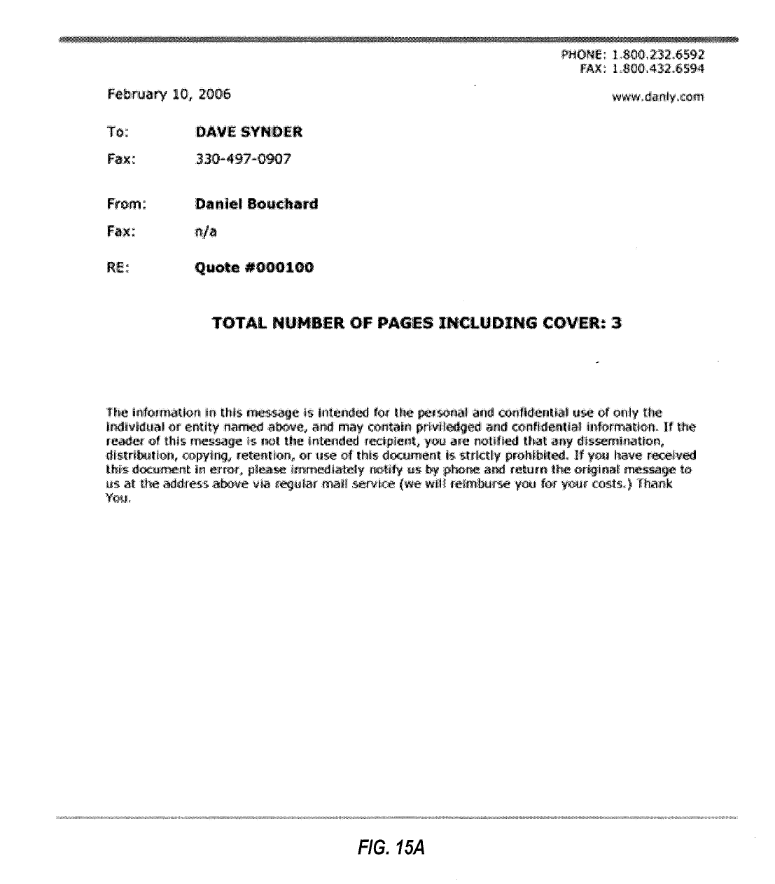

FIG. 14A-14F illustrates the quote cycle of the fourth component added to the current quote. Upon BTO customer 104 approval, a BTO user 120 may access the quote as shown in FIG. 14A. The BTO user 120 then reviews the component preview and bill of materials as shown in FIG. 14B. If changes are necessary, BTO user 120 may edit component parameters as shown in FIG. 14C and FIG. 14D. Once satisfied with the BTO product to be manufactured, BTO user 120 may make the order as shown in FIG. 14E. A quote order page, as shown in FIG. 14F, allows BTO user 120 to review address and customer information, override shipping information, if necessary, submit email and/or fax to BTO customers, and save changes to the RFQ. BTO user 120 may then place the final order if all of the information is correct and approved.

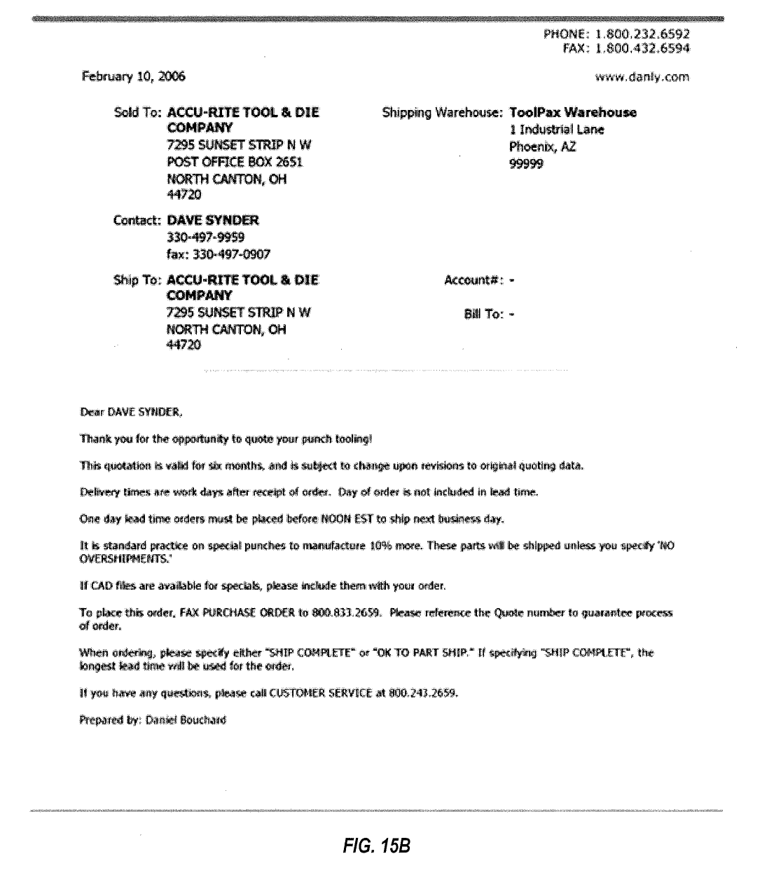

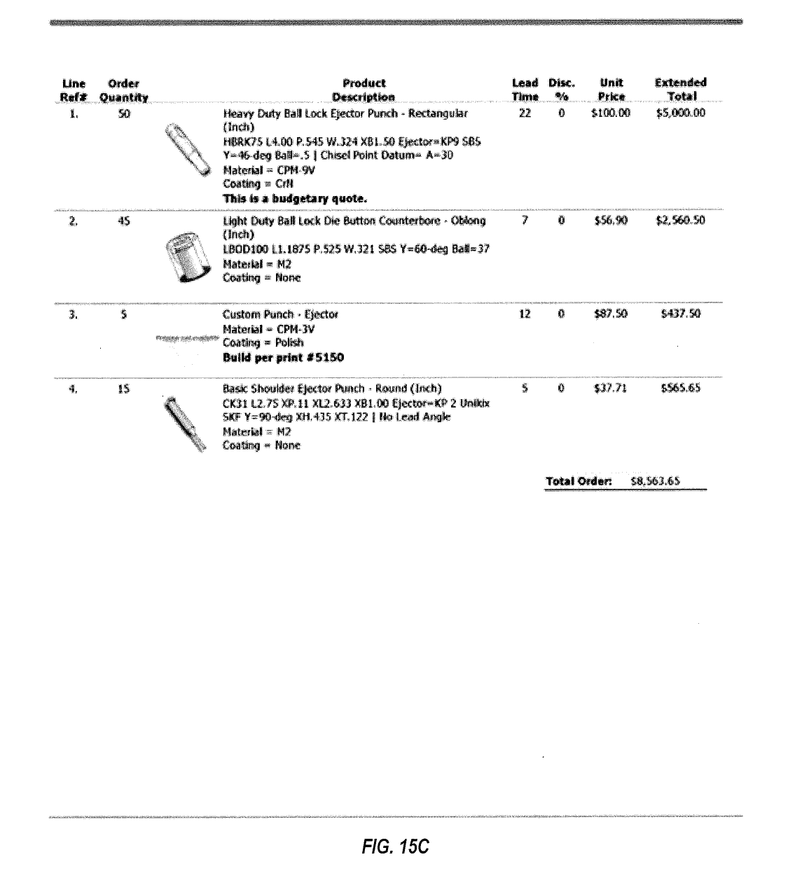

FIGS. 15A-15C illustrate screen shots of sample emails and/or faxes transmitted to BTO customer 104 as part of RFQ client response 116, shown in FIG. 1. In FIG. 15A a cover page is shown. FIG. 15B and FIG. 15C include ordering instructions and a final bill of materials. As shown in FIG. 15C, images of the generated model 152 may be embedded onto the quote form allowing BTO user 120 or BTO customer 104 to preview custom or altered standard products. Additionally, the images may contain hyperlinks to the digital engineering models. BTO user 120 may click on the image to download the engineering model. Thus, BTO user 120 may obtain a fully-defined engineering model of the desired custom or altered product in real-time.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for automating quotes for build-to-order (BTO) engineering products, comprising:
receiving a request for quote (RFQ) for a BTO product from a BTO user;
generating a DNA product string based on information contained in the RFQ, the DNA product string defining the BTO product;
validating the DNA product string against pre-defined business rules;
generating a model of the BTO product based on the DNA product string; and
determining a quote for the BTO product based upon the RFQ, the model and the DNA product string, the quote including one or more of a price, a delivery schedule and a bill of materials.

2. The method of claim 1, wherein the BTO user is a representative of a BTO company.

3. The method of claim 1, wherein the BTO user is a representative of the BTO customer.

4. The method of claim 1, the step of determining comprising determining an estimated weight for the BTO product from the model, the weight being used to determine the quote.

5. The method of claim 1, wherein the step of receiving comprises interacting with the BTO user to define the BTO product.

6. The method of claim 5, further comprising interactively validating, in real time, information entered by the BTO user.

7. The method of claim 1, wherein the step of receiving comprises uploading data from the BTO user to define the BTO product.

8. The method of claim 1, wherein the step of receiving comprises interacting with the BTO user and uploading data to define the BTO product.

9. The method of claim 6, further comprising launching automated routing based on the captured design to produce automated routing instructions.

10. The method of claim 9, further comprising releasing the automated routing instructions to the machine shop to manufacture the BTO product.

11. A computer system for automating quotes for build-to-order (BTO) engineering products, comprising:
a user interface for receiving and validating interactive input from a BTO user to form a request-for-quote (RFQ) for a BTO product;
a DNA coder-decoder (CODEC) for converting manufacturer specific part numbers to and from a generic DNA product string that defines the BTO product;
a modeler for generating a solid model of the BTO product based upon the generic DNA product string;
a plurality of business rules that include cost and production information of a BTO company; and
an estimator for generating a quote for manufacturing the BTO product based upon the generic DNA product string, the solid model and the plurality of business rules.

12. The computer system of claim 11, further comprising:
means for receiving the request for quote (RFQ) for the BTO product from the BTO user;
means for generating the generic DNA product string based on information contained in the RFQ, the generic DNA product string defining the BTO product;
means for validating the DNA product string against pre-defined business rules;
means for generating the solid model of the BTO product based on the DNA product string; and
means for determining the quote for the BTO product based upon the RFQ, the model and the generic DNA product string, the quote including one or more of a price, a delivery schedule and a bill of materials.

13. A software product comprising instructions, stored on computer-readable media, wherein the instructions, when executed by a computer, perform steps for automating quotes for build-to-order (BTO) engineering products, comprising:
instruction for receiving a request for quote (RFQ) from a BTO user for a BTO product;
instruction for generating a DNA product string based on information contained in the RFQ, the DNA product string defining the BTO product;
instruction for validating the DNA product string against pre-defined business rules;
instruction for generating a model of the BTO product based on the DNA product string; and
instruction for determining a quote for the BTO product based upon the RFQ, the model and the DNA product string, the quote including one or more of a price, a delivery schedule and a bill of materials.

14. The software product of claim 13, the instructions for determining comprising instructions for determining an estimated weight for the BTO product from the model, the weight being used to determine the quote.

15. The software product of claim 13, wherein the instructions for receiving comprise instructions for interacting with the BTO user to define the BTO product.

16. The software product of claim 15, further comprising instructions for interactively validating, in real-time, information entered by the BTO user.

17. The software product of claim 13, wherein the instructions for receiving comprise instructions for uploading data from the BTO user to define the BTO product.

18. The software product of claim 13, wherein the instructions for receiving comprise instructions for interacting with the BTO user and uploading data to define the BTO product.

19. The software product of claim 16, further comprising instructions for launching automated routing based on the captured design to produce automated routing instructions.

20. The software product of claim 19, further comprising instructions for releasing the automated routing instructions to the machine shop to manufacture the BTO product.
